(19) United States
(12) Patent Application Publication
(10) Pub. No.: US 2025/0110630 A1
(43) Pub. Date: Apr. 3, 2025

(54) USER INTERFACES AND TECHNIQUES FOR DISPLAYING INFORMATION

(71) Applicant: Apple Inc., Cupertino, CA (US)

(72) Inventors: Gemma A. ROPER, San Francisco, CA (US); Christopher P. FOSS, San Francisco, CA (US); Andrew S. KIM, Walnut Creek, CA (US); David A. KRIMSLEY, Sunnyvale, CA (US); Christopher D. MATTHEWS, San Francisco, CA (US); Corey K. WANG, Palo Alto, CA (US); Arian BEHZADI, San Francisco, CA (US)

(21) Appl. No.: 18/895,559

(22) Filed: Sep. 25, 2024

Related U.S. Application Data
(60) Provisional application No. 63/587,111, filed on Sep. 30, 2023.
(60) Provisional application No. 63/587,110, filed on Sep. 30, 2023.
(60) Provisional application No. 63/587,112, filed on Sep. 30, 2023.

(51) Int. Cl. G06F 3/04847; G06F 3/0487; G06F 3/14

(52) U.S. Cl. CPC G06F 3/04847; G06F 3/0487; G06F 3/1454

(57) ABSTRACT

The present disclosure generally relates to selectively displaying information. For example, the present disclosure relates to displaying controls via an external display, displaying information via an external display based on the location of a computer system, and selectively displaying a user interface via an external display.

### CROSS-REFERENCE TO RELATED APPLICATIONS

This application claims priority to U.S. Provisional Patent Application Ser. No. 63/587,111 entitled “USER INTERFACES AND TECHNIQUES FOR DISPLAYING INFORMATION,” filed Sep. 30, 2023, to U.S. Provisional Patent Application Ser. No. 63/587,110 entitled “TECHNIQUES AND USER INTERFACES FOR DISPLAYING CONTROLS,” filed Sep. 30, 2023, and to U.S. Provisional Patent Application Ser. No. 63/587,112 entitled “TECHNIQUES AND USER INTERFACES FOR CONTROLLING ONE OR MORE ELECTRONIC DEVICES,” filed Sep. 30, 2023, which are incorporated by reference herein in their entireties for all purposes.

### FIELD

The present disclosure relates generally to computer user interfaces, and more specifically to techniques for selectively displaying information.

### BACKGROUND

Computer systems often display information via external displays. Such information can optionally be displayed on both the computer system and the external display.

### SUMMARY

Some techniques for selectively displaying information using computer systems, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides computer systems with faster, more efficient methods and interfaces for selectively displaying information. Such methods and interfaces optionally complement or replace other methods for selectively displaying information. Such methods and interfaces reduce the cognitive burden on a user and produce a more efficient human-machine interface. For battery-operated computing devices, such methods and interfaces conserve power and increase the time between battery charges.

In some embodiments, a method that is performed at a computer system that is in communication with a display component and a physical input mechanism is described. In some embodiments, the method comprises: displaying, via the display component, a respective user interface that includes information that is displayed in a first portion of the respective user interface, a second portion of the respective user interface, and a third portion of the respective user interface; while displaying the information in the first, second, and third portions of the respective user interface, detecting an input directed to the physical input mechanism; and in response to detecting the input directed to the physical input mechanism: in accordance with a determination the physical input mechanism is associated with a first side: displaying, via the display component, one or more user interface objects in the first portion of the respective user interface, wherein the one or more user interface objects are updated based on one or more inputs directed to the physical input mechanism; and moving display of the information such that the information is displayed in the second portion and the third portion of the respective user interface; and in accordance with a determination the physical input mechanism is associated with a second side that is different from the first side: displaying, via the display component, the one or more user interface objects in the third portion of the respective user interface; and moving display of the information such that the information is displayed in the first portion and the second portion of the respective user interface.

In some embodiments, a non-transitory computer-readable storage medium storing one or more programs configured to be executed by one or more processors of a computer system that is in communication with a display component and a physical input mechanism is described. In some embodiments, the one or more programs includes instructions for: displaying, via the display component, a respective user interface that includes information that is displayed in a first portion of the respective user interface, a second portion of the respective user interface, and a third portion of the respective user interface; while displaying the information in the first, second, and third portions of the respective user interface, detecting an input directed to the physical input mechanism; and in response to detecting the input directed to the physical input mechanism: in accordance with a determination the physical input mechanism is associated with a first side: displaying, via the display component, one or more user interface objects in the first portion of the respective user interface, wherein the one or more user interface objects are updated based on one or more inputs directed to the physical input mechanism; and moving display of the information such that the information is displayed in the second portion and the third portion of the respective user interface; and in accordance with a determination the physical input mechanism is associated with a second side that is different from the first side: displaying, via the display component, the one or more user interface objects in the third portion of the respective user interface; and moving display of the information such that the information is displayed in the first portion and the second portion of the respective user interface.

In some embodiments, a transitory computer-readable storage medium storing one or more programs configured to be executed by one or more processors of a computer system that is in communication with a display component and a physical input mechanism is described. In some embodiments, the one or more programs includes instructions for: displaying, via the display component, a respective user interface that includes information that is displayed in a first portion of the respective user interface, a second portion of the respective user interface, and a third portion of the respective user interface; while displaying the information in the first, second, and third portions of the respective user interface, detecting an input directed to the physical input mechanism; and in response to detecting the input directed to the physical input mechanism: in accordance with a determination the physical input mechanism is associated with a first side: displaying, via the display component, one or more user interface objects in the first portion of the respective user interface, wherein the one or more user interface objects are updated based on one or more inputs directed to the physical input mechanism; and moving display of the information such that the information is displayed in the second portion and the third portion of the respective user interface; and in accordance with a determination the physical input mechanism is associated with a second side that is different from the first side: displaying, via the display component, the one or more user interface objects in the third portion of the respective user interface; and moving display of the information such that the information is displayed in the first portion and the second portion of the respective user interface.

In some embodiments, a computer system that is in communication with a display component and a physical input mechanism is described. In some embodiments, the computer system that is in communication with a display component and a physical input mechanism comprises one or more processors and memory storing one or more programs configured to be executed by the one or more processors. In some embodiments, the one or more programs includes instructions for: displaying, via the display component, a respective user interface that includes information that is displayed in a first portion of the respective user interface, a second portion of the respective user interface, and a third portion of the respective user interface; while displaying the information in the first, second, and third portions of the respective user interface, detecting an input directed to the physical input mechanism; and in response to detecting the input directed to the physical input mechanism: in accordance with a determination the physical input mechanism is associated with a first side: displaying, via the display component, one or more user interface objects in the first portion of the respective user interface, wherein the one or more user interface objects are updated based on one or more inputs directed to the physical input mechanism; and moving display of the information such that the information is displayed in the second portion and the third portion of the respective user interface; and in accordance with a determination the physical input mechanism is associated with a second side that is different from the first side: displaying, via the display component, the one or more user interface objects in the third portion of the respective user interface; and moving display of the information such that the information is displayed in the first portion and the second portion of the respective user interface.

In some embodiments, a computer system that is in communication with a display component and a physical input mechanism is described. In some embodiments, the computer system that is in communication with a display component and a physical input mechanism comprises means for performing each of the following steps: displaying, via the display component, a respective user interface that includes information that is displayed in a first portion of the respective user interface, a second portion of the respective user interface, and a third portion of the respective user interface; while displaying the information in the first, second, and third portions of the respective user interface, detecting an input directed to the physical input mechanism; and in response to detecting the input directed to the physical input mechanism: in accordance with a determination the physical input mechanism is associated with a first side: displaying, via the display component, one or more user interface objects in the first portion of the respective user interface, wherein the one or more user interface objects are updated based on one or more inputs directed to the physical input mechanism; and moving display of the information such that the information is displayed in the second portion and the third portion of the respective user interface; and in accordance with a determination the physical input mechanism is associated with a second side that is different from the first side: displaying, via the display component, the one or more user interface objects in the third portion of the respective user interface; and moving display of the information such that the information is displayed in the first portion and the second portion of the respective user interface.

In some embodiments, a computer program product is described. In some embodiments, the computer program product comprises one or more programs configured to be executed by one or more processors of a computer system that is in communication with a display component and a physical input mechanism. In some embodiments, the one or more programs include instructions for: displaying, via the display component, a respective user interface that includes information that is displayed in a first portion of the respective user interface, a second portion of the respective user interface, and a third portion of the respective user interface; while displaying the information in the first, second, and third portions of the respective user interface, detecting an input directed to the physical input mechanism; and in response to detecting the input directed to the physical input mechanism: in accordance with a determination the physical input mechanism is associated with a first side: displaying, via the display component, one or more user interface objects in the first portion of the respective user interface, wherein the one or more user interface objects are updated based on one or more inputs directed to the physical input mechanism; and moving display of the information such that the information is displayed in the second portion and the third portion of the respective user interface; and in accordance with a determination the physical input mechanism is associated with a second side that is different from the first side: displaying, via the display component, the one or more user interface objects in the third portion of the respective user interface; and moving display of the information such that the information is displayed in the first portion and the second portion of the respective user interface.

In some embodiments, a method that is performed at a computer system that is in communication with a display component and a respective device is described. In some embodiments, the method comprises: detecting an input; and in response to detecting the input: in accordance with a determination that a set of one or more criteria is met, causing the respective device to display one or more controls, wherein the set of one or more criteria includes a criterion that is met when the respective device is at a predetermined location; and in accordance with a determination that the set of one or more criteria is not met, displaying, via the display component, the one or more controls without causing the respective device to display the one or more controls.

In some embodiments, a non-transitory computer-readable storage medium storing one or more programs configured to be executed by one or more processors of a computer system that is in communication with a display component and a respective device is described. In some embodiments, the one or more programs includes instructions for: detecting an input; and in response to detecting the input: in accordance with a determination that a set of one or more criteria is met, causing the respective device to display one or more controls, wherein the set of one or more criteria includes a criterion that is met when the respective device is at a predetermined location; and in accordance with a determination that the set of one or more criteria is not met, displaying, via the display component, the one or more controls without causing the respective device to display the one or more controls.

In some embodiments, a transitory computer-readable storage medium storing one or more programs configured to be executed by one or more processors of a computer system that is in communication with a display component and a respective device is described. In some embodiments, the one or more programs includes instructions for: detecting an input; and in response to detecting the input: in accordance with a determination that a set of one or more criteria is met, causing the respective device to display one or more controls, wherein the set of one or more criteria includes a criterion that is met when the respective device is at a predetermined location; and in accordance with a determination that the set of one or more criteria is not met, displaying, via the display component, the one or more controls without causing the respective device to display the one or more controls.

In some embodiments, a computer system that is in communication with a display component and a respective device is described. In some embodiments, the computer system that is in communication with a display component and a respective device comprises one or more processors and memory storing one or more programs configured to be executed by the one or more processors. In some embodiments, the one or more programs includes instructions for: detecting an input; and in response to detecting the input: in accordance with a determination that a set of one or more criteria is met, causing the respective device to display one or more controls, wherein the set of one or more criteria includes a criterion that is met when the respective device is at a predetermined location; and in accordance with a determination that the set of one or more criteria is not met, displaying, via the display component, the one or more controls without causing the respective device to display the one or more controls.

In some embodiments, a computer system that is in communication with a display component and a respective device is described. In some embodiments, the computer system that is in communication with a display component and a respective device comprises means for performing each of the following steps: detecting an input; and in response to detecting the input: in accordance with a determination that a set of one or more criteria is met, causing the respective device to display one or more controls, wherein the set of one or more criteria includes a criterion that is met when the respective device is at a predetermined location; and in accordance with a determination that the set of one or more criteria is not met, displaying, via the display component, the one or more controls without causing the respective device to display the one or more controls.

In some embodiments, a computer program product is described. In some embodiments, the computer program product comprises one or more programs configured to be executed by one or more processors of a computer system that is in communication with a display component and a respective device. In some embodiments, the one or more programs include instructions for: detecting an input; and in response to detecting the input: in accordance with a determination that a set of one or more criteria is met, causing the respective device to display one or more controls, wherein the set of one or more criteria includes a criterion that is met when the respective device is at a predetermined location; and in accordance with a determination that the set of one or more criteria is not met, displaying, via the display component, the one or more controls without causing the respective device to display the one or more controls.

In some embodiments, a method that is performed at a computer system that is in communication with a display component and a respective device is described. In some embodiments, the method comprises: while the respective device is displaying a respective user interface, detecting an input; and in response to detecting the input: in accordance with a determination that the respective user interface is a first type of user interface, causing the respective device to display one or more controls; and in accordance with a determination that the respective user interface is a second type of user interface that is different from the first type of user interface, displaying, via the display component, the one or more controls without causing the respective device to display the one or more controls.

In some embodiments, a non-transitory computer-readable storage medium storing one or more programs configured to be executed by one or more processors of a computer system that is in communication with a display component and a respective device is described. In some embodiments, the one or more programs includes instructions for: while the respective device is displaying a respective user interface, detecting an input; and in response to detecting the input: in accordance with a determination that the respective user interface is a first type of user interface, causing the respective device to display one or more controls; and in accordance with a determination that the respective user interface is a second type of user interface that is different from the first type of user interface, displaying, via the display component, the one or more controls without causing the respective device to display the one or more controls.

In some embodiments, a transitory computer-readable storage medium storing one or more programs configured to be executed by one or more processors of a computer system that is in communication with a display component and a respective device is described. In some embodiments, the one or more programs includes instructions for: while the respective device is displaying a respective user interface, detecting an input; and in response to detecting the input: in accordance with a determination that the respective user interface is a first type of user interface, causing the respective device to display one or more controls; and in accordance with a determination that the respective user interface is a second type of user interface that is different from the first type of user interface, displaying, via the display component, the one or more controls without causing the respective device to display the one or more controls.

In some embodiments, a computer system that is in communication with a display component and a respective device is described. In some embodiments, the computer system that is in communication with a display component and a respective device comprises one or more processors and memory storing one or more programs configured to be executed by the one or more processors. In some embodiments, the one or more programs includes instructions for: while the respective device is displaying a respective user interface, detecting an input; and in response to detecting the input: in accordance with a determination that the respective user interface is a first type of user interface, causing the respective device to display one or more controls; and in accordance with a determination that the respective user interface is a second type of user interface that is different from the first type of user interface, displaying, via the display component, the one or more controls without causing the respective device to display the one or more controls.

In some embodiments, a computer system that is in communication with a display component and a respective device is described. In some embodiments, the computer system that is in communication with a display component and a respective device comprises means for performing each of the following steps: while the respective device is displaying a respective user interface, detecting an input; and in response to detecting the input: in accordance with a determination that the respective user interface is a first type of user interface, causing the respective device to display one or more controls; and in accordance with a determination that the respective user interface is a second type of user interface that is different from the first type of user interface, displaying, via the display component, the one or more controls without causing the respective device to display the one or more controls.

In some embodiments, a computer program product is described. In some embodiments, the computer program product comprises one or more programs configured to be executed by one or more processors of a computer system that is in communication with a display component and a respective device. In some embodiments, the one or more programs include instructions for: while the respective device is displaying a respective user interface, detecting an input; and in response to detecting the input: in accordance with a determination that the respective user interface is a first type of user interface, causing the respective device to display one or more controls; and in accordance with a determination that the respective user interface is a second type of user interface that is different from the first type of user interface, displaying, via the display component, the one or more controls without causing the respective device to display the one or more controls.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for selectively displaying information, thereby increasing the effectiveness, efficiency, and user satisfaction with such devices. Such methods and interfaces may complement or replace other methods for selectively displaying information.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 is a block diagram illustrating a system with various components in accordance with some embodiments.

FIGS. 2A-2E illustrate exemplary user interfaces for displaying controls via an external display in accordance with some examples.

FIGS. 3A-3B are a flow diagram illustrating a method for displaying controls via an external display in accordance with some examples.

FIGS. 4A-4F illustrate exemplary user interfaces for selectively displaying controls in accordance with some examples.

FIG. 5 is a flow diagram illustrating a method for displaying information via an external display based on the location of a computer system in accordance with some examples.

FIG. 6 is a flow diagram illustrating a method for selectively displaying a user interface via an external display in accordance with some examples.

### DETAILED DESCRIPTION

The following description sets forth exemplary techniques for selectively displaying information. This description is not intended to limit the scope of this disclosure but is instead provided as a description of example implementations.

Users need electronic devices that provide effective techniques for selectively displaying information. Efficient techniques can reduce a user's mental load when selectively displaying information. This reduction in mental load can enhance user productivity and make the device easier to use. In some embodiments, the techniques described herein can reduce battery usage and processing time (e.g., by providing user interfaces that require fewer user inputs to operate).

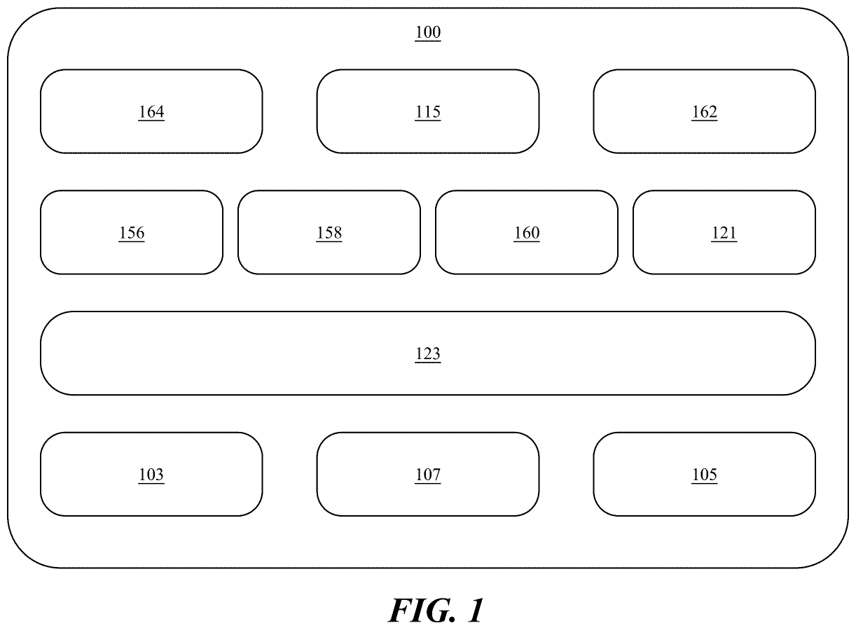

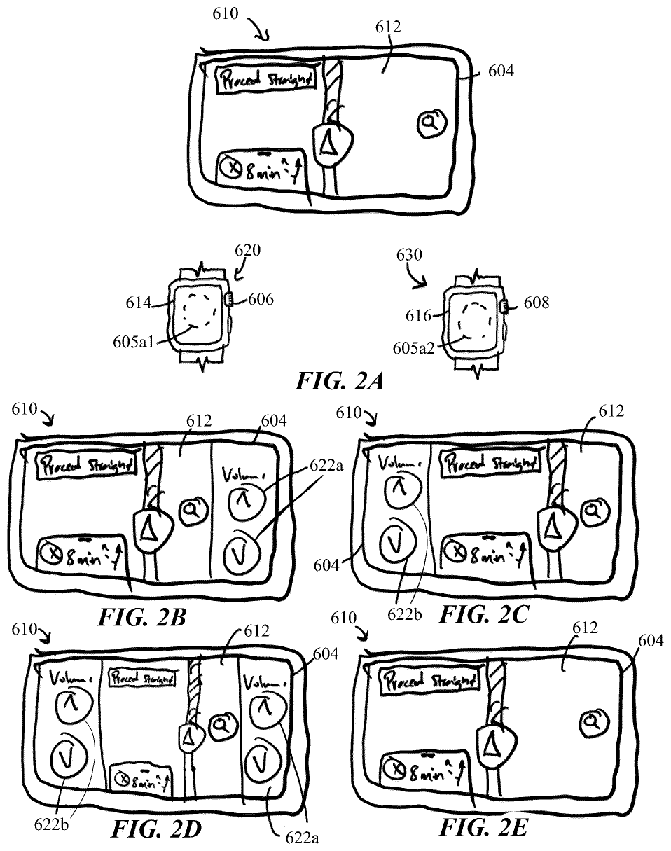

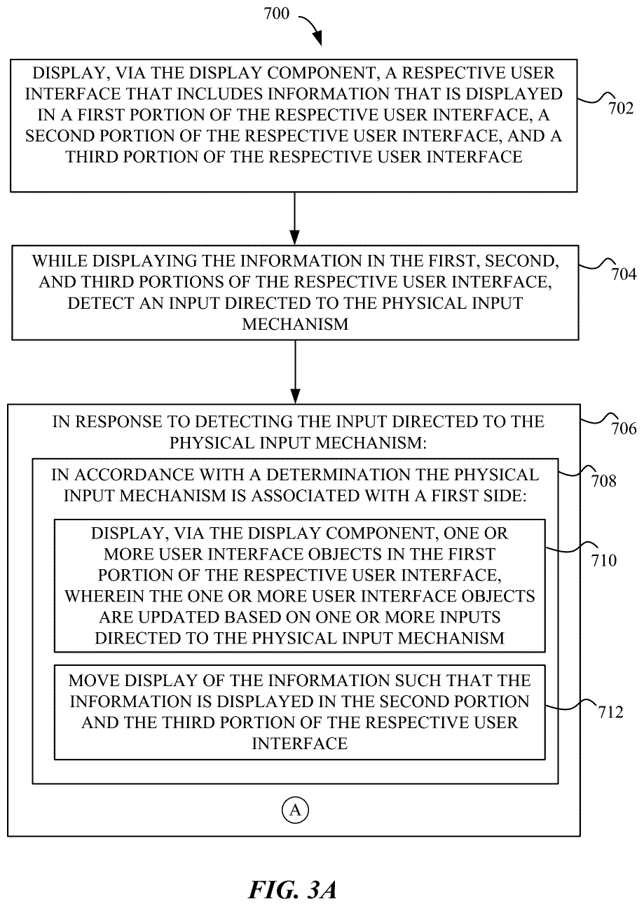

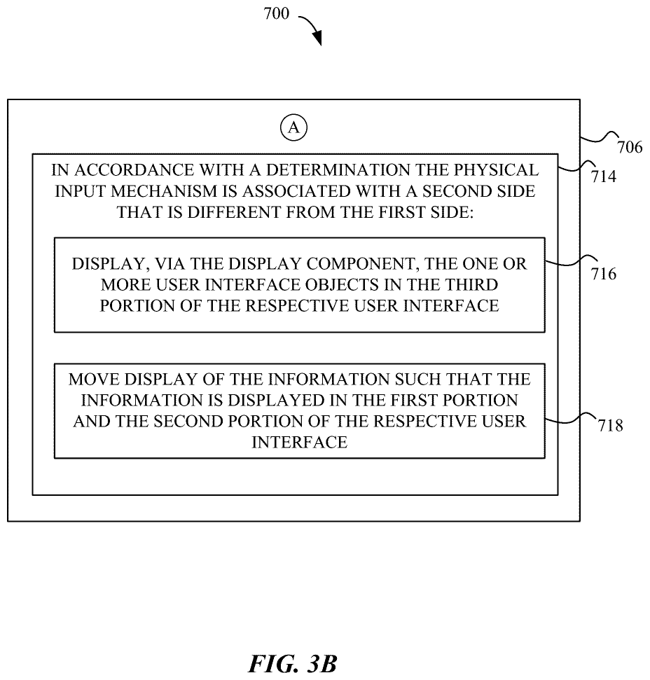

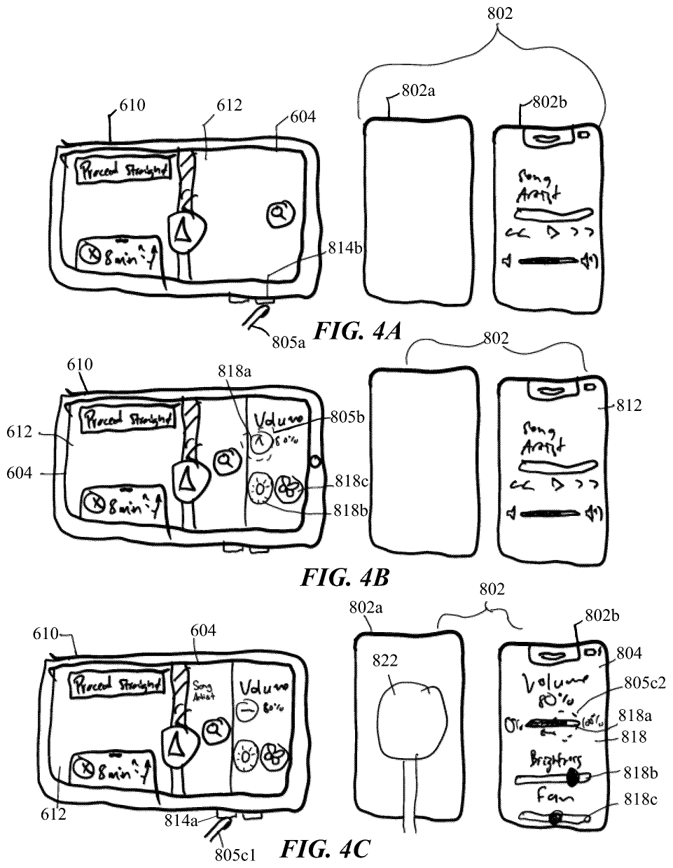

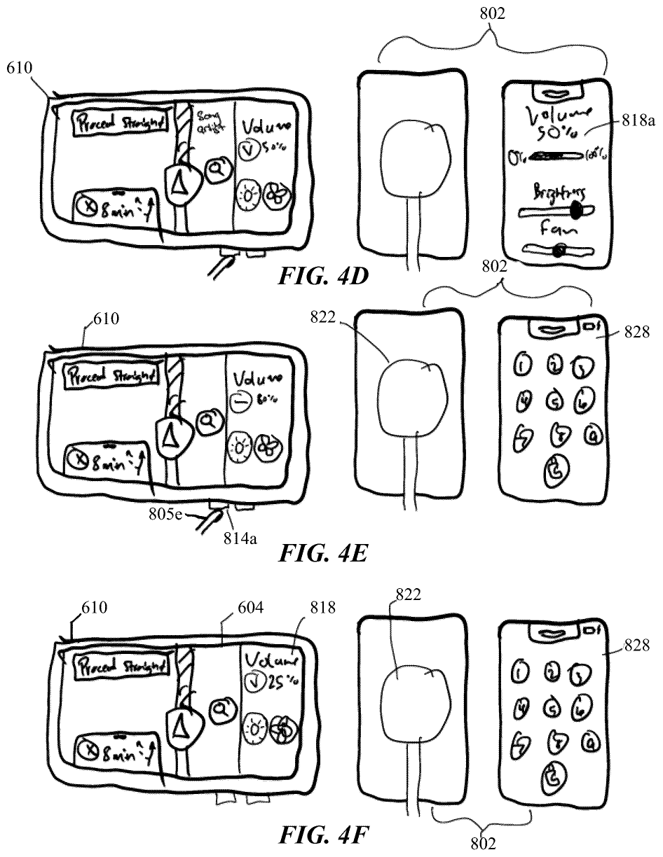

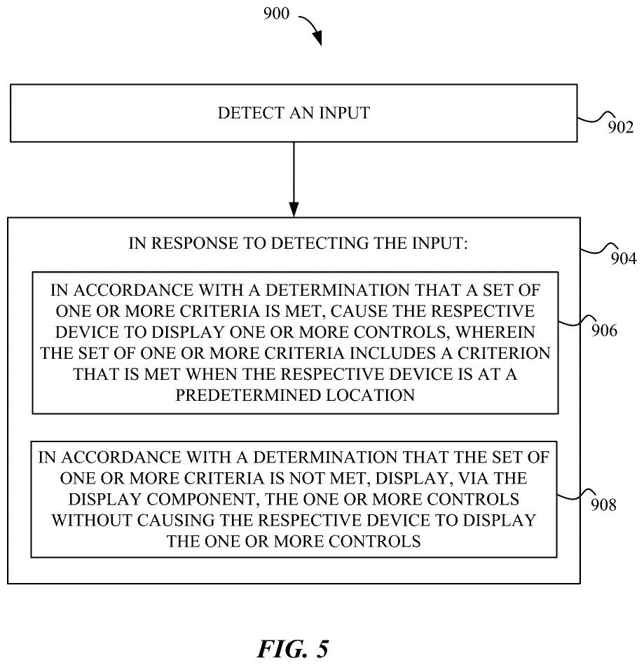

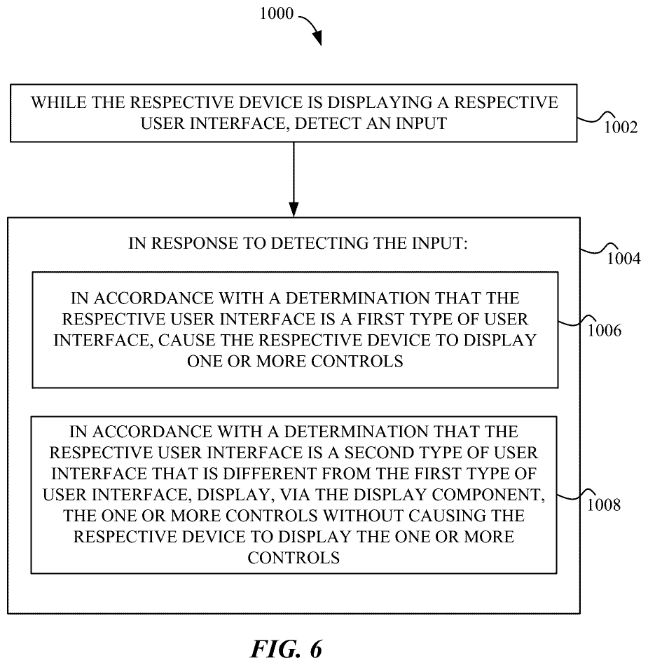

FIG. 1 provides illustrations of exemplary devices for performing techniques for selectively displaying information. FIGS. 2A-2E illustrate exemplary user interfaces for displaying controls via an external display in accordance with some examples. FIGS. 3A-3B are a flow diagram illustrating methods of displaying controls via an external display in accordance with some examples. The user interfaces in FIGS. 2A-2E are used to illustrate the processes described below, including the processes in FIGS. 3A-3B. FIGS. 4A-4F illustrate exemplary user interfaces for selectively displaying controls in accordance with some examples. FIG. 5 is a flow diagram illustrating methods of displaying information via an external display in accordance with some examples. FIG. 6 is a flow diagram illustrating methods of selectively displaying a user interface via an external display in accordance with some examples. The user interfaces in FIGS. 4A-4F are used to illustrate the processes described below, including the processes in FIGS. 5-6.

The processes below describe various techniques for making user interfaces and/or human-computer interactions more efficient (e.g., by helping the user to quickly and easily provide inputs and preventing user mistakes when operating a device). These techniques sometimes reduce the number of inputs needed for a user (e.g., a person and/or a user) to perform an operation, provide clear and/or meaningful feedback (e.g., visual, acoustic, and/or haptic feedback) to the user so that the user knows what has happened or what to expect, provide additional information and controls without cluttering the user interface, and/or perform certain operations without requiring further input from the user. Since the user can use a device more quickly and easily, these techniques sometimes improve battery life and/or reduce power usage of the device.

In methods described where one or more steps are contingent on one or more conditions having been satisfied, it should be understood that the described method can be repeated in multiple repetitions so that over the course of the repetitions all of the conditions upon which steps in the method are contingent have been satisfied in different repetitions of the method. For example, if a method requires performing a first step if a condition is satisfied, and a second step if the condition is not satisfied, it should be appreciated that the steps are repeated until the condition has been both satisfied and not satisfied, in no particular order. Thus, a method described with one or more steps that are contingent upon one or more conditions having been satisfied could be rewritten as a method that is repeated until each of the conditions described in the method has been satisfied. This multiple repetition, however, is not required of system or computer readable medium claims where the system or computer readable medium contains instructions for performing conditional operations that require that one or more conditions be satisfied before the operations occur. A person having ordinary skill in the art would also understand that, similar to a method with conditional steps, a system or computer readable storage medium can repeat the steps of a method as many times as are needed to ensure that all of the conditional steps have been performed.

The terminology used in the description of the various embodiments is for the purpose of describing particular embodiments only and is not intended to be limiting.

User interfaces for electronic devices, and associated processes for using these devices, are described below. In some embodiments, the device is a desktop computer with a touch-sensitive surface (e.g., a touch screen display and/or a touchpad). In other embodiments, the device is a portable, movable, and/or mobile electronic device (e.g., a processor, a smart phone, a smart watch, a tablet, a fitness tracking device, a laptop, a head-mounted display (HMD) device, a communal device, a vehicle, a media device, a smart speaker, a smart display, a robot, a television and/or a personal computing device).

In some embodiments, the electronic device is a computer system that is in communication with a display component (e.g., by wireless or wired communication). The display component may be integrated into the computer system or may be separate from the computer system. Additionally, the display component may be configured to provide visual output to a display (e.g., a liquid crystal display, an OLED display, or CRT display). As used herein, “displaying” content includes causing to display the content (e.g., video data rendered or decoded by a display controller) by transmitting, via a wired or wireless connection, data (e.g., image data or video data) to an integrated or external display component to visually produce the content. In some embodiments, visual output is any output that is capable of being perceived by the human eye, including, and not limited to images, videos, graphs, charts, and other graphical representations of data.

In some embodiments, the electronic device is a computer system that is in communication with an audio generation component (e.g., by wireless or wired communication). The audio generation component may be integrated into the computer system or may be separate from the computer system. Additionally, the audio generation component may be configured to provide audio output. Examples of an audio generation component include a speaker, a home theater system, a soundbar, a headphone, an earphone, an earbud, a television speaker, an augmented reality headset speaker, an audio jack, an optical audio output, a Bluetooth audio output, and/or an HDMI audio output). In some embodiments, audio output is any output that is capable of being perceived by the human ear, including, and not limited to sound waves, music, speech, and/or other audible representations of data.

In the discussion that follows, an electronic device that includes particular input and output devices is described. It should be understood, however, that the electronic device optionally includes one or more other input and/or output devices, such as physical user-interface devices (e.g., a physical keyboard, a mouse, and/or a joystick).

FIG. 1 illustrates an example system 100 for implementing techniques described herein. System 100 can perform any of the methods described in FIGS. 3, 5, and/or 6 (e.g., processes 700, 900, and/or 1000) and/or portions of these methods.

In FIG. 1, system 100 includes various components, such as processor(s) 103, RF circuitry(ies) 105, memory(ies) 107, sensors 156 (e.g., image sensor(s), orientation sensor(s), location sensor(s), heart rate monitor(s), temperature sensor(s)), input device(s) 158 (e.g., camera(s) (e.g., a periscope camera, a telephoto camera, a wide-angle camera, and/or an ultra-wide-angle camera), depth sensor(s), microphone(s), touch sensitive surface(s), hardware input mechanism(s), and/or rotatable input mechanism(s)), mobility components (e.g., actuator(s) (e.g., pneumatic actuator(s), hydraulic actuator(s), and/or electric actuator(s)), motor(s), wheel(s), movable base(s), rotatable component(s), translation component(s), and/or rotatable base(s)) and output device(s) 160 (e.g., speaker(s), display component(s), audio generation component(s), haptic output device(s), display screen(s), projector(s), and/or touch-sensitive display(s)). These components optionally communicate over communication bus(es) 123 of the system. Although shown as separate components, in some implementations, various components can be combined and function as a single component, such as a sensor can be an input device.

In some embodiments, system 100 is a mobile and/or movable device (e.g., a tablet, a smart phone, a laptop, head-mounted display (HMD) device, and or a smartwatch). In other embodiments, system 100 is a desktop computer, an embedded computer, and/or a server.

In some embodiments, processor(s) 103 includes one or more general processors, one or more graphics processors, and/or one or more digital signal processors. In some embodiments, memory(ies) 107 is one or more non-transitory computer-readable storage mediums (e.g., flash memory and/or random-access memory) that store computer-readable instructions configured to be executed by processor(s) 103 to perform techniques described herein.

In some embodiments, RF circuitry(ies) 105 includes circuitry for communicating with electronic devices and/or networks (e.g., the Internet, intranets, and/or a wireless network, such as cellular networks and wireless local area networks (LANs)). In some embodiments, RF circuitry(ies) 105 includes circuitry for communicating using near-field communication and/or short-range communication, such as Bluetooth® or Ultra-wideband.

In some embodiments, display(s) 121 includes one or more monitors, projectors, and/or screens. In some embodiments, display(s) 121 includes a first display for displaying images to a first eye of a user and a second display for displaying images to a second eye of the user. In such embodiments, corresponding images can be simultaneously displayed on the first display and the second display. Optionally, the corresponding images include the same virtual objects and/or representations of the same physical objects from different viewpoints, resulting in a parallax effect that provides the user with the illusion of depth of the objects on the displays. In some embodiments, display(s) 121 is a single display. In such embodiments, corresponding images are simultaneously displayed in a first area and a second area of the single display for each eye of the user. Optionally, the corresponding images include the same virtual objects and/or representations of the same physical objects from different viewpoints, resulting in a parallax effect that provides a user with the illusion of depth of the objects on the single display.

In some embodiments, system 100 includes touch-sensitive surface(s) 115 for receiving user inputs, such as tap inputs and swipe inputs. In some embodiments, display(s) 121 and touch-sensitive surface(s) 115 form touch-sensitive display(s).

In some embodiments, sensor(s) 156 includes sensors for detecting various conditions. In some embodiments, sensor(s) 156 includes orientation sensors (e.g., orientation sensor(s) 111) for detecting orientation and/or movement of platform 150. For example, system 100 uses orientation sensors to track changes in the location and/or orientation (sometimes collectively referred to as position) of system 100, such as with respect to physical objects in the physical environment. In some embodiments, sensor(s) 156 includes one or more gyroscopes, one or more inertial measurement units, and/or one or more accelerometers. In some embodiments, sensor(s) 156 includes a global positioning sensor (GPS) for detecting a GPS location of platform 150. In some embodiments, sensor(s) 156 includes a radar system, LIDAR system, sonar system, image sensors (e.g., image sensor(s) 109, visible light image sensor(s), and/or infrared sensor(s)), depth sensor(s), rangefinder(s), and/or motion detector(s). In some embodiments, sensor(s) 156 includes sensors that are in an interior portion of system 100 and/or sensors that are on an exterior of system 100. In some embodiments, system 100 uses sensor(s) 156 (e.g., interior sensors) to detect a presence and/or state (e.g., location and/or orientation) of a passenger in the interior portion of system 100. In some embodiments, system 100 uses sensor(s) 156 (e.g., external sensors) to detect a presence and/or state of an object external to system 100. In some embodiments, system 100 uses sensor(s) 156 to receive user inputs, such as hand gestures and/or other air gesture. In some embodiments, system 100 uses sensor(s) 156 to detect the location and/or orientation of system 100 in the physical environment. In some embodiments, system 100 uses sensor(s) 156 to navigate system 100 along a planned route, around obstacles, and/or to a destination location. In some embodiments, sensor(s) 156 include one or more sensors for identifying and/or authenticating a user of system 100, such as a fingerprint sensor and/or facial recognition sensor.

In some embodiments, image sensor(s) includes one or more visible light image sensor, such as charged coupled device (CCD) sensors, and/or complementary metal-oxide-semiconductor (CMOS) sensors operable to obtain images of physical objects. In some embodiments, image sensor(s) includes one or more infrared (IR) sensor(s), such as a passive IR sensor or an active IR sensor, for detecting infrared light. For example, an active IR sensor can include an IR emitter, such as an IR dot emitter, for emitting infrared light. In some embodiments, image sensor(s) includes one or more camera(s) configured to capture movement of physical objects. In some embodiments, image sensor(s) includes one or more depth sensor(s) configured to detect the distance of physical objects from system 100. In some embodiments, system 100 uses CCD sensors, cameras, and depth sensors in combination to detect the physical environment around system 100. In some embodiments, image sensor(s) includes a first image sensor and a second image sensor different form the first image sensor. In some embodiments, system 100 uses image sensor(s) to receive user inputs, such as hand gestures and/or other air gestures. In some embodiments, system 100 uses image sensor(s) to detect the location and/or orientation of system 100 in the physical environment.

In some embodiments, system 100 uses orientation sensor(s) for detecting orientation and/or movement of system 100. For example, system 100 can use orientation sensor(s) to track changes in the location and/or orientation of system 100, such as with respect to physical objects in the physical environment. In some embodiments, orientation sensor(s) includes one or more gyroscopes, one or more inertial measurement units, and/or one or more accelerometers.

In some embodiments, system 100 uses microphone(s) to detect sound from one or more users and/or the physical environment of the one or more users. In some embodiments, microphone(s) includes an array of microphones (including a plurality of microphones) that optionally operate in tandem, such as to identify ambient noise or to locate the source of sound in space (e.g., inside system 100 and/or outside of system 100) of the physical environment.

In some embodiments, input device(s) 158 includes one or more mechanical and/or electrical devices for detecting input, such as button(s), slider(s), knob(s), switch(es), remote control(s), joystick(s), touch-sensitive surface(s), keypad(s), microphone(s), and/or camera(s). In some embodiments, input device(s) 158 include one or more input devices inside system 100. In some embodiments, input device(s) 158 include one or more input devices (e.g., a touch-sensitive surface and/or keypad) on an exterior of system 100.

In some embodiments, output device(s) 160 include one or more devices, such as display(s), monitor(s), projector(s), speaker(s), light(s), and/or haptic output device(s). In some embodiments, output device(s) 160 includes one or more external output devices, such as external display screen(s), external light(s), and/or external speaker(s). In some embodiments, output device(s) 160 includes one or more internal output devices, such as internal display screen(s), internal light(s), and/or internal speaker(s).

In some embodiments, environment controls 162 includes mechanical and/or electrical systems for monitoring and/or controlling conditions of an internal portion (e.g., cabin) of system 100. In some embodiments, environmental controls 162 includes fan(s), heater(s), air conditioner(s), and/or thermostat(s) for controlling the temperature and/or airflow within the interior portion of system 100.

In some embodiments, mobility component(s) includes mechanical and/or electrical components that enable a platform to move and/or assist in the movement of the platform. In some embodiments, mobility system 164 includes powertrain(s), drivetrain(s), motor(s) (e.g., an electrical motor), engine(s), power source(s) (e.g., battery(ies)), transmission(s), suspension system(s), speed control system(s), and/or steering system(s). In some embodiments, one or more elements of mobility component(s) are configured to be controlled autonomously or manually (e.g., via system 100 and/or input device(s) 158).

In some embodiments, system 100 performs monetary transactions with or without another computer system. For example, system 100, or another computer system associated with and/or in communication with system 100 (e.g., via a user account described below), is associated with a payment account of a user, such as a credit card account or a checking account. To complete a transaction, system 100 can transmit a key to an entity from which goods and/or services are being purchased that enables the entity to charge the payment account for the transaction. As another example, system 100 stores encrypted payment account information and transmits this information to entities from which goods and/or services are being purchased to complete transactions.

System 100 optionally conducts other transactions with other systems, computers, and/or devices. For example, system 100 conducts transactions to unlock another system, computer, and/or device and/or to be unlocked by another system, computer, and/or device. Unlocking transactions optionally include sending and/or receiving one or more secure cryptographic keys using, for example, RF circuitry(ies) 105.

In some embodiments, system 100 is capable of communicating with other computer systems and/or electronic devices. For example, system 100 can use RF circuitry(ies) 105 to access a network connection that enables transmission of data between systems for the purpose of communication. Example communication sessions include phone calls, e-mails, SMS messages, and/or videoconferencing communication sessions.

In some embodiments, videoconferencing communication sessions include transmission and/or receipt of video and/or audio data between systems participating in the videoconferencing communication sessions, including system 100. In some embodiments, system 100 captures video and/or audio content using sensor(s) 156 to be transmitted to the other system(s) in the videoconferencing communication sessions using RF circuitry(ies) 105. In some embodiments, system 100 receives, using the RF circuitry(ies) 105, video and/or audio from the other system(s) in the videoconferencing communication sessions, and presents the video and/or audio using output device(s) 160, such as display(s) 121 and/or speaker(s). In some embodiments, the transmission of audio and/or video between systems is near real-time, such as being presented to the other system(s) with a delay of less than 0.1, 0.5, 1, or 3 seconds from the time of capturing a respective portion of the audio and/or video.

In some embodiments, the system 100 generates tactile (e.g., haptic) outputs using output device(s) 160. In some embodiments, output device(s) 160 generates the tactile outputs by displacing a moveable mass relative to a neutral position. In some embodiments, tactile outputs are periodic in nature, optionally including frequency(ies) and/or amplitude(s) of movement in two or three dimensions. In some embodiments, system 100 generates a variety of different tactile outputs differing in frequency(ies), amplitude(s), and/or duration/number of cycle(s) of movement included. In some embodiments, tactile output pattern(s) includes a start buffer and/or an end buffer during which the movable mass gradually speeds up and/or slows down at the start and/or at the end of the tactile output, respectively.

In some embodiments, tactile outputs have a corresponding characteristic frequency that affects a “pitch” of a haptic sensation that a user feels. For example, higher frequency(ies) corresponds to faster movement(s) by the moveable mass whereas lower frequency(ies) corresponds to slower movement(s) by the moveable mass. In some embodiments, tactile outputs have a corresponding characteristic amplitude that affects a “strength” of the haptic sensation that the user feels. For example, higher amplitude(s) corresponds to movement over a greater distance by the moveable mass, whereas lower amplitude(s) corresponds to movement over a smaller distance by the moveable mass. In some embodiments, the “pitch” and/or “strength” of a tactile output varies over time.

In some embodiments, tactile outputs are distinct from movement of system 100. For example, system 100 can includes tactile output device(s) that move a moveable mass to generate tactile output and can include other moving part(s), such as motor(s), wheel(s), axel(s), control arm(s), and/or brakes that control movement of system 100. Although movement and/or cessation of movement of system 100 generates vibrations and/or other physical sensations in some situations, these vibrations and/or other physical sensations are distinct from tactile outputs. In some embodiments, system 100 generates tactile output independent from movement of system 100 For example, system 100 can generate a tactile output without accelerating, decelerating, and/or moving system 100 to a new position.

In some embodiments, system 100 detects gesture input(s) made by a user. In some embodiments, gesture input(s) includes touch gesture(s) and/or air gesture(s), as described herein. In some embodiments, touch-sensitive surface(s) 115 identify touch gestures based on contact patterns (e.g., different intensities, timings, and/or motions of objects touching or nearly touching touch-sensitive surface(s) 115). Thus, touch-sensitive surface(s) 115 detect a gesture by detecting a respective contact pattern. For example, detecting a finger-down event followed by detecting a finger-up (e.g., liftoff) event at (e.g., substantially) the same position as the finger-down event (e.g., at the position of a user interface element) can correspond to detecting a tap gesture on the user interface element. As another example, detecting a finger-down event followed by detecting movement of a contact, and subsequently followed by detecting a finger-up (e.g., liftoff) event can correspond to detecting a swipe gesture. Additional and/or alternative touch gestures are possible.

In some embodiments, an air gesture is a gesture that a user performs without touching input device(s) 158. In some embodiments, air gestures are based on detected motion of a portion (e.g., a hand, a finger, and/or a body) of a user through the air. In some embodiments, air gestures include motion of the portion of the user relative to a reference. Example references include a distance of a hand of a user relative to a physical object, such as the ground, an angle of an arm of the user relative to the physical object, and/or movement of a first portion (e.g., hand or finger) of the user relative to a second portion (e.g., shoulder, another hand, or another finger) of the user. In some embodiments, detecting an air gesture includes detecting absolute motion of the portion of the user, such as a tap gesture that includes movement of a hand in a predetermined pose by a predetermined amount and/or speed, or a shake gesture that includes a predetermined speed or amount of rotation of a portion of the user.

In some embodiments, detecting one or more inputs includes detecting speech of a user. In some embodiments, system 100 uses one or more microphones of input device(s) 158 to detect the user speaking one or more words. In some embodiments, system 100 parses and/or communicates information to one or more other systems to determine contents of the speech of the user, including identifying words and/or obtaining a semantic understanding of the words. For example, system processor(s) 103 can be configured to perform natural language processing to detect one or more words and/or determine a likely meaning of the one or more words in the sequence spoken by the user. Additionally or alternatively, in some embodiments, the system 100 determines the meaning of the one or more words in the sequence spoken based upon a context of the user determined by the system 100.

In some embodiments, system 100 outputs spatial audio via output device(s) 160. In some embodiments, spatial audio is output in a particular position. For example, system 100 can play a notification chime having one or more characteristics that cause the notification chime to be generated as if emanating from a first position relative to a current viewpoint of a user (e.g., “spatializing” and/or “spatialization” including audio being modified in amplitude, filtered, and/or delayed to provide a perceived spatial quality to the user).

In some embodiments, system 100 presents visual and/or audio feedback indicating a position of a user relative to a current viewpoint of another user, thereby informing the other user about an updated position of the user. In some embodiments, playing audio corresponding to a user includes changing one or more characteristics of audio obtained from another computer system to mimic an effect of placing an audio source that generates the play back of audio within a position corresponding to the user, such as a position within a three-dimensional environment that the user moves to, spawns at, and/or is assigned to. In some embodiments, a relative magnitude of audio at one or more frequencies and/or groups of frequencies is changed, one or more filters are applied to audio (e.g., directional audio filters), and/or the magnitude of audio provided via one or more channels are changed (e.g., increased or decreased) to create the perceived effect of the physical audio source. In some embodiments, the simulated position of the simulated audio source relative to a floor of the three-dimensional environment matches an elevation of a head of a participant providing audio that is generated by the simulated audio source, or is a predetermined one or more elevations relative to the floor of the three-dimensional environment. In some embodiments, in accordance with a determination that the position of the user will correspond to a second position, different from the first position, and that one or more first criteria are satisfied, system 100 presents feedback including generating audio as if emanating from the second position.

In some embodiments, system 100 communicates with one or more accessory devices. In some embodiments, one or more accessory devices is integrated with system 100. In some embodiments, one or more accessory devices is external to system 100. In some embodiments, system 100 communicates with accessory device(s) using RF circuitry(ies) 105 and/or using a wired connection. In some embodiments, system 100 controls operation of accessory device(s), such as door(s), window(s), lock(s), speaker(s), light(s), and/or camera(s). For example, system 100 can control operation of a motorized door of system 100. As another example, system 100 can control operation of a motorized window included in system 100. In some embodiments, accessory device(s), such as remote control(s) and/or other computer systems (e.g., smartphones, media players, tablets, computers, and/or wearable devices) functioning as input devices control operations of system 100. For example, a wearable device (e.g., a smart watch) functions as a key to initiate operation of an actuation system of system 100. In some embodiments, system 100 acts as an input device to control operations of another system, device, and/or computer, such as the system 100 functioning as a key to initiate operation of an actuation system of a platform associated with another system, device, and/or computer.

In some embodiments, digital assistant(s) help a user perform various functions using system 100. For example, a digital assistant can provide weather updates, set alarms, and perform searches locally and/or using a network connection (e.g., the Internet) via a natural-language interface. In some embodiments, a digital assistant accepts requests at least partially in the form of natural language commands, narratives, requests, statements, and/or inquiries. In some embodiments, a user requests an informational answer and/or performance of a task using the digital assistant. For example, in response to receiving the question “What is the current temperature?,” the digital assistant answers “It is 30 degrees.” As another example, in response to receiving a request to perform a task, such as “Please invite my family to dinner tomorrow,” the digital assistant can acknowledge the request by playing spoken words, such as “Yes, right away,” and then send the requested calendar invitation on behalf of the user to each family member of the user listed in a contacts list for the user. In some embodiments, during performance of a task requested by the user, the digital assistant engages with the user in a sustained conversation involving multiple exchanges of information over a period of time. Other ways of interacting with a digital assistant are possible to request performance of a task and/or request information. For example, the digital assistant can respond to the user in other forms, e.g., displayed alerts, text, videos, animations, music, etc. In some embodiments, the digital assistant includes a client-side portion executed on system 100 and a server-side portion executed on a server in communication with system 100. The client-side portion can communicate with the server through a network connection using RF circuitry(ies) 105. The client-side portion can provide client-side functionalities, input and/or output processing and/or communication with the server, for example. In some embodiments, the server-side portion provides server-side functionalities for any number client-side portions of multiple systems.

In some embodiments, system 100 is associated with one or more user accounts. In some embodiments, system 100 saves and/or encrypts user data, including files, settings, and/or preferences in association with particular user accounts. In some embodiments, user accounts are password-protected and system 100 requires user authentication before accessing user data associated with an account. In some embodiments, user accounts are associated with other system(s), device(s), and/or server(s). In some embodiments, associating one user account with multiple systems enables those systems to access, update, and/or synchronize user data associated with the user account. For example, the systems associated with a user account can have access to purchased media content, a contacts list, communication sessions, payment information, saved passwords, and other user data. Thus, in some embodiments, user accounts provide a secure mechanism for a customized user experience.

Attention is now directed towards embodiments of user interfaces (“UI”) and associated processes that are implemented on an electronic device, such as system 100.

FIGS. 2A-2E illustrate exemplary user interfaces for displaying controls via an external display in accordance with some examples. The user interfaces in these figures are used to illustrate the processes described below, including the processes in FIGS. 3A-3B.

FIG. 2A illustrates a physical configuration of different computer systems (e.g., computer system 610, computer system 620, and computer system 630) in accordance with some embodiments described herein. The physical configuration is intended to illustrate how the different computer systems are physically located relative to each other in one example. As illustrated in FIG. 2A, computer system 620 is located on the left side (e.g., closer to a left portion than a right portion) of computer system 610 and computer system 630 is located on the right side (e.g., closer to a right portion than a left portion) of computer system 610. In some embodiments, the different computer systems are incorporated into (e.g., integrated and/or are a part of) a common external structure (e.g., a house, an apartment, a plane, a train, and/or car). It should be recognized that other physical configurations are possible and that the physical configuration illustrated in FIG. 2A is to provide context for the description herein and for illustrative purposes only.

As illustrated in FIG. 2A, computer system 610 is a smart tablet and includes display 604 (e.g., a display component), computer system 620 is a smartwatch and includes display 614 and rotatable input mechanism 606, and computer system 630 is also a smart watch and includes display 616 and rotatable input mechanism 608. In some embodiments, computer systems 620, 630 are input mechanisms for providing input to computer system 610. In such embodiments, computer system 610 performs one or more operations in response to detecting input detected at computer system 620 and/or computer system 630.

It should be understood that the types of computer systems and components described above are merely exemplary and are merely provided to give context to the embodiments described herein. In some embodiments, a rotatable input mechanism (e.g., 606) is positioned on the surface of a display (e.g., 614) (e.g., the rotatable input mechanism can be positioned in the center of the display, where the display surrounds the rotatable input mechanism). In some embodiments, a display (e.g., 614) is positioned within a rotatable input mechanism (e.g., 606) (e.g., the rotatable input mechanism encompasses the display). In some embodiments, a display (e.g., 614) is positioned above, below, or beneath a rotatable input mechanism (e.g., 606) within the housing of a computer system (e.g., 620). Other examples of computer systems include a knob, a dial, joystick, touch-sensitive surface, button, slider, smart phone, television, projector, monitor, smart display, laptop, and/or personal computer.

In some embodiments, at least two of computer system 610, computer system 620, and computer system 630 are in communication with each other (e.g., wired and/or wireless communication (e.g., Bluetooth, Wi-Fi, and/or Ultra-Wideband)). In some embodiments, computer system 610 is in communication with computer system 620 and computer system 630 while computer system 620 and computer system 630 are not in communication. In other examples, computer system 620 and computer system 630 are in communication, and either computer system 620 or computer system 630 is not in communication with computer system 610.

As illustrated in FIG. 2A, computer system 620 and computer system 630 are not displaying a respective user interface on their respective displays. That is, as illustrated in FIG. 2A, computer system 620 and computer system 630 are operating in a sleep mode. However, the following description is applicable while computer system 620 and computer system 630 are in various operating modes. In some embodiments, computer system 620 and computer system 630 are displaying respective user interfaces (e.g., the same user interface or different user interface). In some embodiments, computer system 620 and computer system 630 are in reduced power operating modes (e.g., a mode where the functionalities of computer system 620 and computer system 630 are reduced to conserve the battery life of computer system 620 and computer system 630), an operating mode that is configured to use less power than a full and/or higher operating mode. In some embodiments, computer system 620 and computer system 630 transitions between operating modes (e.g., transitions from a sleep mode to a normal and/or higher power operating mode) in response to detecting an input.

As illustrated in FIG. 2A, computer system 610 displays navigation user interface 612. Navigation user interface 612 includes a map that corresponds to the positioning of computer system 610 and a current route. In some embodiments, navigation user interface 612 provides real-time navigation instructions to a user that are dynamic as computer system 610 moves. For example, the display of navigation user interface 612 can change based on changes to the location of computer system 610. As illustrated in FIG. 2A, computer system 610 displays navigation user interface 612 on the entirety of display 604.

The display of navigation user interface 612 is merely exemplary and the following description is applicable while computer system 610 displays any respective type of user interface. Examples of other types of user interfaces include a multimedia user interface (reflecting multimedia that is currently being played or configured to be played), weather user interface (reflecting weather in an area associated with computer system 610), and a control user interface (for controlling different computer systems, such as devices (e.g., a fan, a lock, a window, and/or the like) in a physical area of the home).

As illustrated in FIG. 2A, computer system 620 detects input 605al and/or computer system 630 detects input 605a2. In some embodiments, each of input 605al and input 605a2 correspond to a tap input (e.g., a tap input on display 614 or display 616), a swipe input (e.g., a swipe input on display 614 or display 616), a rotation of rotatable input mechanism 606 or rotatable input mechanism 608, and/or a depression of rotatable input mechanism 606 or rotatable input mechanism 608. In some embodiments, input 605al is the same type of input as input 605a2. In other embodiments, input 605al is a different type of input than input 605a2 (e.g., input 605al is a tap input and input 605a2 is a swipe input).

FIGS. 2B-2D depict various scenarios of the behavior of computer system 610 when different inputs are detected by computer system 620 and/or computer system 630. For example, FIG. 2B illustrates display 604 when computer system 630 detects input 605a2 and computer system 620 does not detect input 605a1. The depiction of display 604 in FIG. 2B can follow the depiction of display 604 in FIGS. 2A, 2C, and/or 2D.

As illustrated in FIG. 2B, in response to computer system 630 detecting input 605a2, computer system 630 transmits instructions to computer system 610. As illustrated in FIG. 2B, in response to receiving the instructions from computer system 630, computer system 610 displays volume controls 622a. As illustrated in FIG. 2B, computer system 610 displays volume controls 622a on the right portion of display 604. The location of the display of volume controls 622a corresponds to the positioning of computer system 630 relative to computer system 610. Accordingly, computer system 610 displays volume controls 622a on the right portion of display 604 because computer system 630 is positioned closer to the right portion of computer system 610 than the left portion of computer system 610. In some embodiments, computer system 630 does not transmit instructions to computer system 610, rather an intermediate computer system and/or another computer system transmits instructions to computer system 610.

In some example, in response to detecting selection of volume controls 622a, the volume of speakers that correspond to computer system 630 (e.g., speakers that are in proximity to computer system 630 and/or are integrated into computer system 630) are adjusted and the volume of speakers that correspond to computer system 620 (e.g., speakers that are in proximity with computer system 620 and/or are integrated into computer system 620) are not adjusted. In some embodiments, in response to detecting selection of volume controls 622a, the volume of speakers that correspond to both computer system 620 and computer system 630 (e.g., speakers that are in proximity with (e.g., and/or on the same side as) computer system 630 and computer system 620 and/or are integrated into computer system 630 and computer system 620) are adjusted. In some embodiments, speakers that correspond to a first user (e.g., the first user is wearing computer system 630) are adjusted and the speakers that correspond to a second user (e.g., the second user is wearing computer system 620) are not adjusted in response to volume controls 622a being selected. In some embodiments, computer system 630 and a pair of respective speakers are on a common side of an external structure. In some embodiments, in response to detecting selection of volume controls 622a, the volume of speakers that are on a common side of an external structure as computer system 630 are adjusted. In some embodiments, in response to detecting selection of volume controls 622a, the volume of speakers that are on an opposite side of an external structure as computer system 630 are adjusted.

Volume controls 622a can be selected via computer system 630. For example, in some embodiments, while computer system 610 displays volume controls 622a, in response to computer system 630 detecting an input (e.g., a tap input on display 616, a rotation of rotatable input mechanism 608 and/or a long press (e.g., a press and hold) on display 616) computer system 630 sends instructions to computer system 610 that cause volume controls 622a to be selected. The volume of the playback of a media item is adjusted (e.g., the volume of the playback of the media item is increased or decreased) in response to volume controls 622a being selected. In some embodiments, volume controls 622a are selected as a part of computer system 610 displaying volume controls 622a. In some embodiments, when display 604 is a touch sensitive display, volume controls 622a are selected via the detection (e.g., by computer system 610) of an input (e.g., a tap, a press and hold, and/or a swipe). In some embodiments, such as when computer system 610 is in communication (e.g., wireless and/or wired communication) with a camera, volume controls 622a are selected in response to detecting (e.g., via the camera) a hand gesture (e.g., an air swipe gesture, an air point gesture, pinch gesture, and/or de-pinch gesture). In some embodiments, the playback of a media item is muted in response to volume controls 622a being selected. In some embodiments, the playback of a media item is unmuted in response to volume controls 622a being selected.

Further, as illustrated in FIG. 2B, in response to receiving the instructions from computer system 630, computer system 610 reduces the size of the display of navigation user interface 612 (e.g., in contrast to the size of navigation user interface 612 in FIG. 2A). Computer system 630 reduces the size of the display of navigation user interface 612 from the right edge of display 604. Further, as illustrated in FIG. 2B, computer system 630 moves the display of navigation user interface 612 as a part of displaying volume controls 622a. Computer system 610 does not modify the display of navigation user interface 612 in response to volume controls 622a being selected. In some embodiments, as a part of moving navigation user interface 612, computer system 610 uniformly reduces the size of information and/or user interface elements within navigation user interface 612, removes details from navigation user interface and/or reduces the number of visible controls that are displayed within navigation user interface 612. In some embodiments, as a part of moving navigation user interface 612, computer system 610 moves the display of navigation user interface 612 from a first portion of display 604 to a second portion of display 604.

As illustrated in FIG. 2B, computer system 610 does not overlap the display of volume controls 622a with the display of navigation user interface 612. Rather, as illustrated in FIG. 2B, computer system 610 displays navigation user interface 612 on the center and left portions of display 604 while computer system 610 displays volume controls 622a on the right portion of display 604. In some embodiments, computer system 610 displays volume controls 622a on the right portion and center portion of display 604 while computer system 610 displays navigation user interface 612 on the left portion of display 604.

FIG. 2C illustrates display 604 when computer system 620 detects input 605al and computer system 630 does not detect input 605a2. The depiction of display 604 in FIG. 2C can follow the depiction of display 604 in FIGS. 2A, 2B, and/or 2D.

As illustrated in FIG. 2C, in response to computer system 620 detecting input 605a1, computer system 630 transmits instructions to computer system 610. As illustrated in FIG. 2C, in response to receiving the instructions from computer system 630, computer system 610 displays volume controls 622b. As illustrated in FIG. 2C, computer system 610 displays volume controls 622b on the left portion of display 604. Similar to volume controls 622a, the location of the display of volume controls 622b corresponds to the positioning of computer system 620. Accordingly, computer system 610 displays volume controls 622b on the left portion of display 604 because computer system 620 is positioned closer to the left portion of computer system 610 than the right portion of computer system 610.

As illustrated in FIG. 2C, computer system 610 displays volume controls 622b on the left portion of display 604 while computer system 610 displays navigation user interface 612 on the center and right portion of display 604. As a part of displaying volume controls 622b, computer system 610 moves the display of navigation user interface 612. In some embodiments, in response to volume controls 622b being selected, the volume of speakers that correspond to computer system 630 (e.g., speakers in proximity to computer system 630 and/or are integrated into computer system 630) are not adjusted and the volume of speakers that correspond to computer system 620 (e.g., speakers in proximity to computer system 620 and/or are integrated into computer system 620) are adjusted. In some embodiments, in response to volume controls 622b being selected, the volume of the playback of speakers that correspond to both computer system 620 and computer system 630 (e.g., are in proximity with computer system 630 and computer system 620 and/or are integrated into computer system 630 and computer system 620) are adjusted.

The display of volume controls 622a and volume controls 622b is merely exemplary. The above description of volume controls 622a and volume controls 622b is applicable to other types of control user interface objects. For example, in response to computer system 610 receiving the instructions from computer system 630, computer system 610 displays a different user interface (e.g., a multimedia user interface, a weather information user interface, and/or a telephone user interface) with one or more selectable control user interface objects based on the context of computer system 610 (e.g., computer system 610 is static (e.g., computer system 610 is static and/or computer system 610 is coupled to a static external object), computer system 610 is moving (e.g., computer system is moving and/or computer system 610 is coupled to a moving external object), the location of computer system 610, and/or the speed at which computer system 610 is moving). In some embodiments, the different interface includes multiple selectable control user interface objects that, when selected, causes the performance of a respective operation (e.g., adjust the playback status of a media item, adjust the temperature in an environment, adjust the speed of a fan, adjust a thermostat, adjust a light, and/or adjust the brightness in an environment) on an external device.

In some embodiments, in response to receiving the instructions from computer system 620 and/or computer system 630, computer system 610 displays a menu that allows a user to select which control user interface objects are displayed. In some embodiments, when computer system 610 is static (e.g., still, not moving, and/or otherwise not being caused to be moved) (e.g., computer system 610 is static and/or computer system 610 is coupled to a static external object), computer system 610 actuates a physical device in response to receiving the instructions from computer system 630 (e.g., and computer system 610 does not display volume controls 622a or volume controls 622b). In some embodiments, computer system 610 displays different types of controls based on the type of input that is detected by computer system 620 and/or computer system 630.

FIG. 2D illustrates display 604 when computer system 620 detects input 605al and computer system 630 detects input 605a2. FIG. 2D can follow any one of FIG. 2A, 2B, or 2C. In some embodiments, computer system 630 detects input 605a2 within a threshold amount of time (e.g., 0.5-10 seconds) of computer system 620 detecting input 605a1. In some embodiments, computer system 630 detects input 605a2 while computer system 610 displays volume controls 622b. In some embodiments, computer system 620 detects input 605al while computer system 610 displays 622a.

As illustrated in FIG. 2D, in response to computer system 630 detecting input 605a2, computer system 630 transmits instructions to computer system 610. As illustrated in FIG. 2D, in response to receiving the instructions from computer system 630, computer system 610 displays volume controls 622a on the right portion of display 604. Further, as illustrated in FIG. 2D, in response to computer system 620 detecting input 605a1, computer system 620 transmits instructions to computer system 610. As illustrated in FIG. 2D, in response to receiving the instructions from computer system 620, computer system 610 displays volume controls 622b on the left portion of display 604.

As illustrated in FIG. 2D, computer system 610 concurrently displays volume controls 622a on the right portion of display 604, volume controls 622b on the left portion of display 604 and navigation user interface 612 in between the display of volume controls 622b and volume controls 622a. Further, as illustrated in FIG. 2D, computer system 610 continues to display navigation user interface 612 while computer system 610 concurrently displays volume controls 622a and volume controls 622b. As a part of concurrently displaying volume controls 622a and volume controls 622b, computer system 610 moves the display of navigation user interface 612. As illustrated in FIG. 2D, computer system 610 does not display navigation user interface 612 on the left portion and right portion of display 604 while computer system 610 concurrently displays volume controls 622b and volume controls 622a.

As illustrated in FIG. 2E a determination is made that computer system 610 has displayed volume controls 622a and/or 622b for predetermined amount of time (e.g., 5, 10, 15, 30, 60, 90, or 120 seconds) since input 605al and/or 605a2 were detected. Because a determination is made that computer system 610 has displayed volume controls 622a and/or 622b for a predetermined amount of time since input 605al and/or 605a2 were detected, computer system 610 ceases to display volume controls 622a and/or 622b. As a part of ceasing to display volume controls 622a and/or volume controls 622b, computer system 610 displays (e.g., redisplays) navigation user interface 612 with its initial appearance (e.g., the appearance of navigation user interface 612 in FIG. 2A). The depiction of display 604 in FIG. 2E can follow the depiction of display 604 in any of FIGS. 2B, 2C and/or 2D. In some embodiments, computer system 610 ceases to display volume controls 622a before computer system 610 ceases to display volume controls 622b or vice versa. In some embodiments, computer system 610 ceases to display navigation user interface 612 and continues to display volume controls 622b and/or 622a.

FIGS. 3A-3B is a flow diagram illustrating a method (e.g., process 700) for displaying controls via an external display in accordance with some examples. Some operations in process 700 are, optionally, combined, the orders of some operations are, optionally, changed, and some operations are, optionally, omitted.

As described below, process 700 provides an intuitive way for displaying controls via an external display. Process 700 reduces the cognitive burden on a user for displaying controls via an external display, thereby creating a more efficient human-machine interface. For battery-operated computing devices, enabling a user to display controls via an external display faster and more efficiently conserves power and increases the time between battery charges.

In some embodiments, process 700 is performed at a computer system (e.g., 610) that is in communication with a display component (e.g., 604) (e.g., a display screen and/or a touch-sensitive display) and a physical input mechanism (e.g., 606 and/or 608) (e.g., a hardware input mechanism, a rotatable input mechanism, a crown, a knob, a dial, a physical slider, and/or a hardware button). In some embodiments, the computer system is a watch, a phone, a tablet, a processor, a head-mounted display (HMD) device, and/or a personal computing device. In some embodiments, the computer system is in communication with one or more cameras (e.g., one or more telephoto, wide angle, and/or ultra-wide-angle cameras). In some embodiments, the computer system is in communication with one or more input devices (e.g., a physical input mechanism (e.g., a hardware input mechanism, a rotatable input mechanism, a crown, a knob, a dial, a physical slider, and/or a hardware button), a camera, a touch-sensitive display, a microphone, and/or a button).

The computer system displays (702), via the display component (e.g., 604), a respective user interface (e.g., 612) that includes information (e.g., navigation information and/or real-time information) that is displayed in (e.g., across, within, and/or overlaid on) a first portion of the respective user interface, a second portion of the respective user interface, and a third portion of the respective user interface. In some embodiments, the first portion is separate from and/or different from (e.g., not encompassed by, does not encompass, and/or does not surround) the second portion. In some embodiments, the second portion is separate from and/or different from the third portion.

While displaying the information in the first, second, and third portions of the respective user interface (e.g., 612), the computer system detects (704) an input directed to the physical input mechanism (e.g., 606 and/or 608) (e.g., an input (e.g., a tap input and/or a rotational input) on a rotatable input mechanism) (and, in some embodiments, a non-tap and/or rotational input, such as a mouse click, gaze input, voice input and/or command, air gesture (e.g., a tap air gesture, a pinch gesture, and/or a flicking air gesture)).

In response to (706) detecting the input directed to the physical input mechanism (e.g., 606 (708) and/or 608) and in accordance with a determination that the physical input mechanism (e.g., 606 and/or 608) is associated with a first side (e.g., a side of a display, the computer system, an area, a region, a container, and/or a room), the computer system displays (710), via the display component (e.g., 604), one or more user interface objects (622a and/or 622b) in the first portion of the respective user interface (e.g., 612), wherein the one or more user interface objects are updated based on one or more inputs directed to the physical input mechanism (e.g., 606 and/or 608). In some embodiments, the one or more user interface objects includes a first user interface object corresponding to a first setting (e.g., a media playback (e.g., play, pause, rewind, skip, proceed to next track, and/or proceed to previous track) setting, a temperature setting, a volume setting, a fan speed setting, and/or a light intensity setting). In some embodiments, in response to detecting selection of the first user interface object, the computer system changes the first setting and/or causes the computer system to send instructions to a device to adjust output based on the changes to the first setting and/or the selection of the first user interface object. In some embodiments, the determination that the physical input mechanism is associated with the first side includes a determination that the physical input mechanism is closer in distance to the first portion than the third portion and/or is closer to the first portion than the third portion.

In response to (706) detecting the input directed to the physical input mechanism and in accordance with the determination the physical input mechanism is associated with the first side, the computer system moves (712) (e.g., sliding, transitioning, resizing, and/or shrinking) display of the information such that the information is displayed in the second portion and the third portion of the respective user interface (e.g., 612) (e.g., without being displayed in the first portion of the respective user interface).

In response to (706) detecting the input directed to the physical input mechanism and in accordance with (714) a determination the physical input mechanism (e.g., 606 and/or 608) is associated with a second side (e.g., a side of a display, the computer system, an area, a region, a container, and/or a room) that is different from the first side, the computer system displays (716), via the display component (e.g., 604), the one or more user interface objects (622a and/or 622b) in the third portion of the respective user interface (e.g., 612). In some embodiments, a first physical input mechanism is configured to be associated with the first side and a second physical input mechanism, different from the first physical input mechanism, is configured to be associated with the second side. In some embodiments, the determination that the physical input mechanism is associated with the second side includes a determination that the physical input mechanism is closer in distance to the third portion than the first portion and/or is closer to the third portion than the first portion.

In response to (706) detecting the input directed to the physical input mechanism and in accordance with (714) the determination the physical input mechanism is associated with the second side that is different from the first side, the computer system moves (718) (e.g., sliding, transitioning, resizing, and/or shrinking) display of the information such that the information is displayed in the first portion and the second portion of the respective user interface (e.g., 612) (e.g., without being displayed in the first portion of the respective user interface). In some embodiments, when the determination is made that the physical input mechanism is associated with the first side, the physical input mechanism is physically coupled and/or closer to the first side than the second side. In some embodiments, when the determination is made that determination the physical input mechanism is associated with the second side, the physical input mechanism is physically coupled and/or closer to the second side than the first side. In response to detecting the input directed to the physical input mechanism and in accordance with a determination the physical input mechanism is associated with a first side or a second side, displaying the one or more user interface objects in different portions of the respective user interface and moving the information previously included in such portions allows the computer system to display content in a portion corresponding to the physical input mechanism and/or a user to more easily context switch between information being displayed and the one or more user interface objects, thereby providing improved visual feedback to the user and/or performing an operation when a set of conditions has been met without requiring further user input.

In some embodiments, the physical input mechanism (e.g., 606 and/or 608) is a rotatable input mechanism (e.g., a knob, crown, and/or dial). In some embodiments, the input directed to the physical input mechanism is a rotating input (e.g., in a clockwise or counterclockwise direction).

In some embodiments, the first side is a side (e.g., and/or of the display component) that is on an opposite side of a display (and/or user interface) than the second side (e.g., with respect to a central location (e.g., location that is in the middle or center)). Displaying the one or more user interface objects on opposite sides of the display depending on which side the physical input mechanism corresponds allows for the computer system to cater to different user perspectives and/or users to more easily context switch between information being displayed and the one or more user interface objects, thereby providing improved visual feedback to the user and/or performing an operation when a set of conditions has been met without requiring further user input.

In some embodiments, the first portion is adjacent to (e.g., next to and/or shares a side and/or point with) the second portion (and, In some embodiments, not adjacent to the third portion). In some embodiments, the third portion is adjacent to the second portion. In some embodiments, the first portion is closer to the first side than the second side. In some embodiments, the third portion is closer to the second side than the first side. In some embodiments, the second portion is as close to the first side as the second portion is to the second side. The first portion, the second portion, and the third portion each being adjacent to the previous with the first portion closer to the first side and the third portion closer to the second side allows for the computer system to cater to different user perspectives and/or users to more easily context switch between information being displayed and the one or more user interface objects, thereby providing improved visual feedback to the user and/or performing an operation when a set of conditions has been met without requiring further user input.

In some embodiments, the physical input mechanism (e.g., 606 and/or 608) is a first physical input mechanism (e.g., 606 and/or 608). In some embodiments, the computer system (e.g., 610) is in communication with a second physical input (e.g., 606 and/or 608) mechanism that is different from the first physical input mechanism. In some embodiments, while displaying the one or more user interface objects (622a and/or 622b) in the first portion of the respective user interface (e.g., 612) and while the information is displayed in the second portion and the third portion of the respective user interface, the computer system detects an input (e.g., 605a1 and/or 605a2) (e.g., a rotational input and/or, in some embodiments, a non-rotational input (e.g., a long-press input, a drag input, a voice input, an air gesture and/or input, a mouse click, and/or a gaze input)) that is directed to the second physical input mechanism. In some embodiments, in response to detecting the input that is directed to the second physical input mechanism, the computer system concurrently displays, via the display component (e.g., 604), one or more respective user interface objects (e.g., 622a and/or 622b) in the third portion of the respective user interface with the one or more user interface objects in the first portion of the respective user interface (e.g., that are updated based on one or more inputs to the physical input mechanism (and not updated based on one or more inputs directed to the second physical input mechanism)), wherein the one or more respective user objects in the third portion are updated based on one or more inputs to the second physical input mechanism (and are not updated based on inputs directed to the first physical input mechanism) (e.g., as discussed above at FIG. 2D). In some embodiments, the one or more respective user interfaces objects displayed in the third portion includes some of the same types of user interface objects as the one or more user interface objects displayed in the first portion. In some embodiments, the one or more respective user interface objects displayed in the third portion and/or the one or more user interface objects displayed in the first portion are concurrently displayed with one or more navigation user interface objects and/or map user interface objects (e.g., one or more user interface objects that, when selected, causes a map to be updated, a compass user interface object, a pan/zoom user interface object that, when selected causes the respective user interface and/or a portion (e.g., the second portion) of the respective user interface to be panned/zoomed, an exit user interface object that, when selected, causes the computer system to cease displaying the one or more user interface objects in the third portion of the respective user interface). In response to detecting the input that is directed to the second physical input mechanism, concurrently displaying the one or more respective user interface objects in the third portion of the respective user interface with the one or more user interface objects in the first portion of the respective user interface allows for the computer system to cater to physical input mechanisms located in different perspectives with respect to the respective user interface and/or users to more easily context switch between information being displayed and the one or more user interface objects in each portion, thereby providing improved visual feedback to the user and/or performing an operation when a set of conditions has been met without requiring further user input.

In some embodiments, in response to detecting the input (e.g., 605al and/or 605a2) that is directed to the second physical input mechanism (e.g., 606 and/or 608), the computer system moves display of the information such that the information is displayed in the second portion of the respective user interface (e.g., 612) without being displayed in the first portion and the third portion of the respective user interface (e.g., as discussed above at FIG. 2D). In some embodiments, the information includes one or more navigation user interface objects and/or map user interface objects (e.g., one or more user interface objects that, when selected, causes a map to be updated, a compass user interface object, a pan/zoom user interface object that, when selected causes the respective user interface and/or a portion (e.g., the second portion) of the respective user interface to be panned/zoomed, an exit user interface object that, when selected, causes the computer system to cease displaying the one or more user interface objects in the third portion of the respective user interface). In response to detecting the input that is directed to the second physical input mechanism, moving display of the information such that the information is displayed in the second portion of the respective user interface without being displayed in the first portion and the third portion of the respective user interface allows for the computer system to cater to different user perspectives and/or users to more easily context switch between information being displayed and one or more user interface objects, thereby providing improved visual feedback to the user and/or performing an operation when a set of conditions has been met without requiring further user input.

In some embodiments, display of the one or more user interface objects (622a and/or 622b) does not overlap (e.g., does cover, is not displayed on top of, and/or is not displayed underneath) with display of the information (e.g., information included in 612). Display of the one or more user interface objects not overlapping with display of the information that is moved for the display of the one or more user interface objects allows for a user to view and/or interact with the one or more user interface objects and/or the information, thereby providing improved visual feedback to the user and/or performing an operation when a set of conditions has been met without requiring further user input.

In some embodiments, the information (e.g., information included in 612) includes navigation information (e.g., route information, destination information, compass information, location information, and/or dynamic information that is updated based on movement of a computer system).

In some embodiments, the navigation information includes a map and a route to a destination. In some embodiments, the route is updated based on movement of the computer system (e.g., 610) (e.g., as discussed above at FIG. 2A) (e.g., in real-time and/or dynamically updated).

In some embodiments, while displaying the one or more user interface objects (622a and/or 622b) that are updated based on one or more inputs directed to the physical input mechanism (e.g., 606 and/or 608), the computer system detects an input (e.g., a tap input and/or, in some embodiments, a non-tap input, such as a mouse click, gaze input, voice input and/or command, air gesture (e.g., a tap air gesture, a pinch gesture, and/or a flicking air gesture)) directed to the one or more user interface objects (e.g., as described above at FIG. 2C). In some embodiments, in response to detecting the input directed to the one or more user interface objects, the computer system causes output of a first device (e.g., a thermostat, fan, light, set of blinds, window, door, and/or speaker) to be adjusted (e.g., to be increased (In some embodiments, from a non-zero amount) and/or decreased (In some embodiments, from a non-zero amount)), wherein the first device is in communication with the computer system (e.g., 610) (e.g., as described above at FIG. 2C). In some embodiments, the computer system is included in a first enclosure and the first device is included in a second enclosure different from the first enclosure. In some embodiments, the computer system is wired or wirelessly connected to the first device. In some embodiments, the first device is external to the computer system. In response to detecting the input directed to the one or more user interface objects, causing the output of the first device to be adjusted allows for users to control the output of the first device while displaying the information and/or using user interface objects displayed in contextual portions of the respective user interface, thereby providing improved visual feedback to the user and/or performing an operation when a set of conditions has been met without requiring further user input.

In some embodiments, in response to detecting the input directed to the one or more user interface objects (622a and/or 622b), the computer system forgoes causing the information (e.g., information included 612) to be adjusted (e.g., as described above at FIG. 2B) (e.g., in response to detecting the input directed to the one or more user interface object (e.g., in some embodiments, the information can be caused to be adjusted upon other factors other than detecting input directed to the one or more user interface objects, such as movement of the computer system)). Forgoing causing the information to be adjusted in response to detecting the input directed to the one or more user interface objects allows for the one or more user interface objects to be used without affecting the information, thereby providing improved visual feedback to the user and/or performing an operation when a set of conditions has been met without requiring further user input.

In some embodiments, the first device is associated with a particular user (and/or a particular user account) that is associated with (e.g., that is currently on, that is detected to be on, and/or that has registered with (e.g., via a device and/or via placing a device at a particular location)) the first side or a particular user (and/or a particular user account) that is associated with the second side (e.g., as described above at FIG. 2B). In some embodiments, a respective device being associated with the particular user includes the respective device being set to a particular value that is determined based on the preferences (e.g., derived preferences, historical preferences, and/or learned preferences) of the user. Adjusting the output of a device associated with a particular user allows for the one or more user interface objects to be used by the particular user for changing their experience rather than changing an experience for other users, thereby providing improved visual feedback to the user and/or performing an operation when a set of conditions has been met without requiring further user input.

In some embodiments, in accordance with a determination that the physical input mechanism (e.g., 606 and/or 608) is associated with the first side, the first device is associated with (e.g., provides output to, is included on, and/or assigned to) the first side and is not associated with (e.g., does not provide output to, is not included on, and/or not assigned to) the second side (e.g., as described above at FIGS. 2B and 2C). In some embodiments, in accordance with a determination that the physical input mechanism is associated with the second side, the first device is associated with (e.g., provides output to, is included on, and/or assigned to) the second side is not associated with (e.g., does not provide output to, is not included on, and/or not assigned to) the second side (e.g., as described above at FIGS. 2B and 2C). In some embodiments, a respective device being associated with a particular side includes the respective device being set to a particular value that is determined based on determined preferences (e.g., derived preferences, historical preferences, and/or learned preferences) of the particular side (e.g., what temperature, sound, and/or light that has been output at the particular side by one or more users). Adjusting the output of a device associated with a particular side (e.g., the first side and not the second side) in response to detecting input from a physical input mechanism associated with the particular side allows for users to intuitively adjust output of devices that are located in areas relative to the physical input mechanism, thereby providing improved visual feedback to the user and/or performing an operation when a set of conditions has been met without requiring further user input.

In some embodiments, in accordance with a determination that the physical input mechanism (e.g., 606 and/or 608) is associated with the first side, output of the first device is directed to (e.g., primarily directed, impacts, is directionally directed to, and/or directionally impacts) the first side (and, in some embodiments, is not directed to and/or directly impacts the second side) (e.g., as explained above at FIG. 2B). In some embodiments, in accordance with a determination that the physical input mechanism is associated with the second side, output of the first device is directed to the second side (e.g., as explained above at FIG. 2B) (and, in some embodiments, is not directed to and/or directly impacts the first side). The output of the first device being directed to the side that the physical input mechanism is associated allows for users to intuitively adjust output of devices that are located in areas relative to the physical input mechanism, thereby providing improved visual feedback to the user and/or performing an operation when a set of conditions has been met without requiring further user input.

In some embodiments, while displaying, via the display component (e.g., 604), the one or more user interface objects (622a and/or 622b) that are updated based on one or more inputs (e.g., 605al and/or 605a2) directed to the physical input mechanism (e.g., 606 and/or 608), the computer system detects whether a first set of one or more criteria is met. In some embodiments, in response to detecting whether the first set of one or more conditions is met and in accordance with a determination that the first set of one or more conditions is met, the computer system ceases display of the one or more user interface objects that are updated based on one or more inputs directed to the physical input mechanism, wherein the first set of one or more conditions includes a condition that is met when a first input (e.g., and/or any input and/or an input) has not been directed to the physical input mechanism for a first period of time (e.g., 30-600 seconds) while the one or more user interface objects are displayed (e.g., as described above at FIG. 2E). In some embodiments, in accordance with a determination that the first set of conditions is not met, the computer system continues to display the one or more user interface objects. Ceasing display of the one or more user interface objects in response to detecting a first input has not been directed to the physical input mechanism for a first period of time while the one or more user interface objects are displayed allows for the one or more user interface object to not continue to take up a portion of the respective user interface when it is determined to be unlikely that a user still wants to use the one or more user interface objects, thereby providing improved visual feedback to the user, reducing the number of inputs needed to perform an operation, providing additional control options without cluttering the user interface with additional displayed controls, and/or performing an operation when a set of conditions has been met without requiring further user input.

In some embodiments, while displaying, via the display component (e.g., 604), the one or more user interface objects (622a and/or 622b) that are updated based on one or more inputs (e.g., 605a1 and/or 605a2) directed to the physical input mechanism (e.g., 606 and/or 608) and while the information (information included in 612) is not displayed in the first portion or the third portion (and, in some embodiments, is displayed in the second portion), the computer system detects whether a second set of one or more conditions is met. In some embodiments, in response to detecting whether the second set of one or more conditions is met and in accordance with a determination that the second set of one or more conditions (e.g., the first set of one or more conditions or at least one different condition than the first set of one or more conditions) is met, the computer system ceases display of the one or more user interface objects (e.g., 622a and/or 622b) that are updated based on one or more inputs directed to the physical input mechanism. In some embodiments, in response to detecting whether the second set of one or more conditions is met and in accordance with the determination that the second set of one or more conditions is met, the computer system moves display of the information such that the information is displayed in the first portion, the second portion, and the third portion, wherein the second set of one or more conditions includes a condition that is met when a second input (e.g., and/or any input and/or any particular input) has not been directed to the physical input mechanism for a second period of time (e.g., 30-600 seconds) (e.g., the first period of time or a different period of time than the first period of time) while the one or more user interface objects are displayed (e.g., as described above at FIG. 2E). In some embodiments, in accordance with a determination that the second set of conditions is not met, the computer system continues to not display the information in the first portion or the third portion. Moving display of the information such that the information is displayed in the first portion, the second portion, and the third portion when a second input has not been directed to the physical input mechanism for the second period of time while the one or more user interface objects are displayed allows for the information to expand and be displayed in more portions of the respective user interface when it is determined to be unlikely that a user still wants to use the one or more user interface objects, thereby providing improved visual feedback to the user, reducing the number of inputs needed to perform an operation, providing additional control options without cluttering the user interface with additional displayed controls, and/or performing an operation when a set of conditions has been met without requiring further user input.

Note that details of the processes described above with respect to process 700 (e.g., FIGS. 3A-3B) are also applicable in an analogous manner to other methods described herein. For example, process 900 optionally includes one or more of the characteristics of the various methods described above with reference to process 700. For example, the controls discussed at process 900 can be displayed within a particular area of a display component based on the location of a respective computer system. For brevity, these details are not repeated below.

FIGS. 4A-4F illustrate exemplary user interfaces for selectively displaying control sin accordance with some examples. The user interfaces in these figures are used to illustrate the processes described below, including the processes in FIG. 5-10. In some embodiments, FIGS. 4A-4F are provided to illustrate an example, where the choice of where particular controls are displayed is dependent on whether or not a first computer system (e.g., 802a and/or 802b) (or second computer system) meets a set of criteria. In some embodiments, when the first computer system meets the set of criteria, the controls are displayed on the computer system; and when the first computer system does not meet the set of criteria, are displayed on the computer system. In some embodiments, when the controls are not displayed on the computer system, the controls are displayed on a shared screen, such as a screen at a central location within an environment and/or at a location that corresponds to a central hub of a computer system and/or an environment. In some embodiments, when the controls are displayed on the computer system, the controls are not displayed on the shared screen. However, in other examples, the controls are displayed on the shared screen, irrespective as to whether the controls are displayed on the computer system or not.

In some embodiments, the set of criteria includes a criterion that is satisfied when a determination is made that the first computer system is connected to a particular location. In some embodiments, the connection is a magnetic connection. In some embodiments, the first computer system is being charged while being connected to the particular location. In some embodiments, no connection is required. In some embodiments, the particular location is within another computer system and/or external structure (e.g., a smart house, a smart car, and/or smart boat), where the first computer system is designed to be a personal device that belongs to an individual user (e.g., such as a smart phone, smart watch, and/or smart ring) and the shared computer system is designed to be shared device for any user of the external structure (e.g., a television in a house and/or a display in a car). In some embodiments, the first computer system is not fixed to an external structure (e.g., by bolts) while the shared computer system is fixed to an external structure. In some embodiments, the first computer system is smaller than the second computer system. In some embodiments, the shared computer system is a command center device for an external structure. Thus, in some embodiments, the set of criteria includes a criterion that is satisfied when a determination is made that the first computer system is not displaying private and/or sensitive information, such as bank account information, health information, and/or the like (e.g., even in cases where the computer system is at the particular location). Because, in some embodiments, displaying the controls on the computer system would remove the private and/or sensitive information from the display. In some embodiments, the set of criteria includes a criterion that is satisfied when a determination is made that the computer system is not in a certain type of communication session, such as text message session, a live video communication session, and/or a voice session (e.g., phone call). In some embodiments, the set of criteria includes a criterion that is satisfied when a determination is made that the computer system is not a particular mode, such as do not disturb mode and/or sleep mode, and/or when a determination is made that a user is not actively using the computer system. It is understood that these criteria are examples and can be modified and/or other criteria can be realized. In some embodiments, FIGS. 4A-4F illustrate other examples and/or concepts, as described below, in addition to and/or in lieu of the immediate examples provided above and/or one or more other benefits can be realized in addition to those described herein.

FIG. 4A illustrates computer system 610 and computer system 802. Computer system 610 and computer system 802 are in communication (e.g., wired and/or wireless (e.g., Bluetooth, Wi-Fi-, and/or Ultra-wideband) communication). As illustrated in FIG. 4A, computer system 802 is a smart phone, and computer system 610 is a smart tablet and/or a shared screen. However, it should be understood that the types of computer systems and components described herein are merely exemplary and are provided to give context to the embodiments described herein. In some embodiments, computer systems 610 and 802 include a knob, a dial, joystick, touch-sensitive surface, button, and/or slider. In some embodiments, computer system 610 and 802 is a smart phone, television, projector, monitor, smart display, laptop, fitness tracking device, and/or personal computer. In some embodiments, computer systems 610 and/or 802 includes one or more components of system 100.

At FIG. 4A, computer system 802 includes frontside 802b and backside 802a. As illustrated in FIG. 4A, computer system 802 displays playback user interface 812 on display 804 of frontside 802b of computer system 802. Playback user interface 812 corresponds to a multimedia application that is installed on computer system 802. As illustrated in FIG. 4A, playback user interface 812 includes media item identifier user interface object 830. Media item identifier user interface object 830 indicates the title and artist of a media item that speakers (e.g., external speakers and/or speakers integrated into computer system 610 and/or computer system 802) are configured playback.

As illustrated in FIG. 4A, computer system 610 displays navigation user interface 612 on display 604 of computer system 610. As described above in relation to FIG. 2A, navigation user interface 612 includes a map that corresponds to the positioning of computer system 610 and real-time directions at FIG. 4A. Further, computer system 610 includes input mechanisms 814a and 814b. Input mechanisms 814a and 814b are independently activated in response to computer system 610 detecting that a respective input mechanism is selected. In some embodiments, computer system 610 and computer system 802 are incorporated into (e.g., integrated and/or are a part of) a common external structure (e.g., a house, an apartment, a plane, a train, a boat, and/or a car). In some embodiments, an external structure is a computer system. At FIG. 4A, computer system 610 detects input 805a that corresponds to an activation of input mechanism 814b. In some embodiments, input 805a corresponds to a rotation of a rotatable input mechanism that is coupled to computer system 610. In some embodiments, input 805a corresponds to a rotation of a rotatable input mechanism that is not coupled to computer system 610. In some embodiments, input 805a corresponds to one or more other types of inputs, such as a rotational input, a swipe input, a tap input, an air gesture, a voice input, and/or a gaze input. In some embodiments, other inputs described below in relation to FIGS. 4A-4F can alternatively be one or more other types of inputs, such as a rotational input, a swipe input, a tap input, an air gesture, a voice input, and/or a gaze input.

FIGS. 4B-4C illustrate the behavior of computer systems 610 and 802 in response to computer system 610 detecting input 805a. More specifically, FIG. 4B illustrates the behavior of computer systems 610 and 802 when computer system 802 is not positioned at a predetermined location when computer system 610 detects input 805a, and FIG. 4C illustrates the behavior of computer systems 610 and 802 when computer system 802 is positioned at the predetermined location when computer system 610 detects input 805a. Either of FIG. 4B or 4C can follow FIG. 4A.

It should be understood that, for exemplary purposes only, computer system 610 is a personal computer, and computer system 802 is a shared screen. In some embodiments, there are more personal computers than shared screens in an environment, where the shared screen functions as a communal device and/or a central hub of an external structure (e.g., a business, a car, and/or a home) and a personal device of a user can communicate with and/or be in communication with the communal device. In some embodiments, a personal device is not fixed and/or attached to a portion of the external structure while a communal device is fixed and/or attached to the portion of the external structure (e.g., fixed or attached such that the respective computer system cannot be readily removed from the external structure without require the use of tools (e.g., screw drivers, drills, and/or the like).

At FIG. 4B, a determination is made that computer system 802 is not positioned at a predetermined location that corresponds to an external charging device (e.g., when and/or after computer system 610 detects input 805a). In some embodiments, the determination is made that computer system 802 is positioned at the predetermined location when a determination is made that computer system 802 is connected to and/or magnetically coupled to a location that includes a magnetic surface. In some embodiments, the computer system 802 connects to the magnetic surface, where the magnetic surface can be popped out and/or extended to extrude above, below, and/or outside of another surface. In some embodiments, the determination is made that computer system 802 is positioned at the predetermined location when a determination is made that computer system 802 is connected to a particular port via a dongle, wire, and/or or some other means of connection.

As illustrated in FIG. 4B, in response to detecting input 805a and because a determination is made that computer system 802 is not positioned at the predetermined location (e.g., when computer system 610 detects input 805a), computer system 610 displays controls user interface 818 (e.g., and computer system 802 does not display controls user interface 818). Controls user interface 818 corresponds to external devices (e.g., speakers, fans, and/or lights) that are in communication (e.g., wired communication and/or wireless communication) with computer system 610 and/or computer system 802. In some embodiments, the predetermined location is proximate to and/or near a rotatable input mechanism (e.g., as described above in relation to FIG. 2A). In some embodiments, the predetermined location is positioned above the rotatable input mechanism. In examples when the predetermined location is proximate to a rotatable input mechanism, the rotatable input mechanism can be raised and/or lowered by depressing the rotatable input mechanism.

As illustrated in FIG. 4B, control user interface 818 includes fan control user interface object 814A, light control user interface object 814B, and volume control user interface object 814C. Computer system 600 causes the operation of an external fan to be adjusted in response to the detection that fan control user interface object 814A is selected. Computer system 600 causes the operation of one or more lights to be adjusted in response to the detection that light control user interface object 814B is selected. Computer system 600 causes the operation of one or more speakers to be adjusted in response to the detection that volume control user interface object 814C is selected. In some embodiments, in response to detecting a selection of a particular control, a computer system sends one or more instructions to an external device (e.g., fan, lights, and/or speakers) that is in communication with the computer system. In some embodiments, while computer system 610 displays control user interface 818, computer system 600 activates one of fan control user interface object 814A, light control user interface object 814B, and volume control user interface object 814C in response to computer system 802 detecting an input. In some embodiments, in response to detecting that a user is proximate (e.g., user is within 1, 3, 5, 7, or 10 feet of computer system 610) to computer system 610, computer system 610 automatically (e.g., without intervening user input) transmits instructions to the external devices that correspond to one or more of fan control user interface object 814A, light control user interface object 814B, and volume control user interface object 814C that cause the external devices to adjust their operation to a predefined user-based setting. In some embodiments, computer system 610 automatically (e.g., without intervening user input) transmits instructions to the external devices that correspond to one or more of fan control user interface object 814A, light control user interface object 814B, and volume control user interface object 814C that cause the external devices to adjust their respective operation based on a combination of user preferences and the context of computer system 610 (e.g., computer system 610 will increase the output of a heater unit if it is determined that computer system 610 is located in a physical environment with an ambient temperature that is lower than the user's preference and/or computer system 610 will decrease the brightness of lights if it is determined that computer system 610 is located in a physical environment with a brightness level that exceeds a user's preference). In some embodiments, the display of each of fan control user interface object 814A, light control user interface object 814B, and volume control user interface object 814C includes the display of a default user-based setting (e.g., a temperature, fan speed value, and volume level that is based on a user's historical use and/or preferences). In some embodiments, computer system 610, computer system 802, the external device that corresponds to fan control user interface object 814A, the external device that corresponds to light control user interface object 814B, and the external device that corresponds to volume control user interface object 814C are all coupled to a common external device (e.g., a house, office building, boat, airplane, or car).

As illustrated in FIG. 4B, computer system 610 displays controls user interface 818 on the right portion of display 604 while computer system 610 displays navigation user interface 612 on the center portion and left portion of display 604. Computer system 610 continues to display navigation user interface 612 while computer system 610 displays controls user interface 818. However, as part of displaying controls user interface 818, computer system 610 moves the location of the display of navigation user interface 612. Further, as part of displaying controls user interface 818, computer system 610 resizes (e.g., reduces the size of the display) the display of navigation user interface 612 (e.g., in contrast to the size of the display of navigation user interface 612 at FIG. 2A). In some embodiments, computer system 610 displays controls user interface 818 on the majority of display 604. In some embodiments, as a part of displaying controls user interface 818, computer system 610 ceases to display navigation user interface 612. In some embodiments, as a part of moving the location of the display of navigation user interface 612, computer system 610 uniformly reduces the size of information and/or user interface elements within navigation user interface 612, removes details from navigation user interface, and/or reduces the number of visible controls that are displayed within navigation user interface 612.

As illustrated in FIG. 4B, computer system 802 continues to display playback user interface 812 while computer system 610 displays controls user interface 818. That is, the display of controls user interface 818 does not impact the display of playback user interface 812 by computer system 802. At FIG. 4B, computer system 610 detects input 805b that corresponds to selection of light control user interface object 814B. In some embodiments, input 805b corresponds to a tap input, a long press (e.g., a tap and hold), air gesture, voice input and/or a swipe input. In some embodiments, when a determination is made that computer system 802 is not positioned at the predetermined position, the detection of an input by computer system 610 does not modify the display of computer system 802. In some embodiments, while computer system 610 displays controls user interface 818, computer system 802 and/or computer system 600 activates one or more of fan control user interface object 814A, light control user interface object 814B and/or volume control user interface object 814C in response to computer system 802 detecting an input.

As explained above, FIGS. 4B and 4C illustrate the behavior of computer systems 610 and 802 in response to computer system 610 detecting input 805a. More specifically, FIG. 4C illustrates the behavior of computer systems 610 and 802 when computer system 802 is positioned at the predetermined location when computer system 610 detects input 805a.

As illustrated in FIG. 4C, backside 802a of computer system 802 is coupled to external charger 822. External charger 822 charges a rechargeable battery that is housed within computer system 802 while computer system 802 is coupled to external charger 822. The location of external charger 822 corresponds to the predetermined location. Accordingly, at FIG. 4C, computer system 802 is positioned at the predetermined location. At FIG. 4C, a determination is made that computer system 802 is at the predetermined location (e.g., computer system 802 is coupled to external charger 822) when computer system 602a detects input 805a (e.g., computer system 610 detects input 805a immediately before, immediately after or while computer system 802 is positioned at the predetermined location). At FIG. 4C, in response to detecting input 805a and because a determination is made that computer system 802 is positioned at the predetermined location, computer system 610 transmits instructions to computer system 802. As illustrated in FIG. 4C, in response to computer system 802 receiving the instructions from computer system 610, computer system 802 displays controls user interface 818 (e.g., and computer system 610 does not display controls user interface 818). The detection of input 805a while computer system 802 is positioned at the predetermined location results in computer system 802 displaying controls user interface 818. In some embodiments, while computer system 802 displays controls user interface 818, one or more of fan control user interface object 814A, light control user interface object 814B and/or volume control user interface object 814C are selected in response to computer system 610 detecting an input.

At FIG. 4C, computer system 802 ceases to display playback user interface 812 as a part of displaying control user interface 818. In some embodiments, computer system 802 is coupled to external charger 822 via a magnetic field. In some embodiments, computer system 802 is coupled to external charger 822 via hardware components (e.g., external charger 822 is inserted into computer system 802). In some embodiments, computer system 802 continues to display playback user interface 812 while computer system 802 displays control user interface 818. In some embodiments, input 805a corresponds to moving computer system 802 to the predetermined location (e.g., coupling computer system 802 to external charger 822).

The display of control user interface 818 on computer system 802 (e.g., at FIG. 4C) differs from the display of control user interface 818 on computer system 610 (e.g., as shown in FIG. 4B). More specifically, computer system 802 displays fan control user interface object 814A, light control user interface object 814B, and volume control user interface object 814C as slider user interface objects. In contrast, computer system 610 displays fan control user interface object 814A, light control user interface object 814B, and volume control user interface object 814C as non-slider user interface objects. Additionally, as illustrated in FIG. 4C, computer system 802 displays control user interface 818 on the majority (e.g., entirety) of display 804. In contrast, computer system 610 displays control user interface on a portion of display 604. In some embodiments, computer system 802 displays fan control user interface object 814A, light control user interface object 814B, and volume control user interface object 814C with a different color, size, shape, and/or positional orientation than the display of fan control user interface object 814A, light control user interface object 814B, and volume control user interface object 814C by computer system 610.

At FIG. 4C, a determination is made that playback user interface 812 is a non-sensitive type of user interface. More specifically, at FIG. 4C, a determination is made that playback user interface 812 does not contain sensitive information such as financial information, health records, private correspondences between individuals, and/or private information related to an individual (e.g., home address, phone number, date of birth, and/or social security number). At FIG. 4C, in response to computer system 610 detecting input 805a while computer system 802 is positioned at the predetermined location and because a determination is made that playback user interface 812 does not contain sensitive information, computer system 802 transmits instructions to computer system 610. As illustrated in FIG. 4C, in response to computer system 610 receiving the instructions, computer system 610 displays media item identifier user interface object 830.

Computer system 610 mimics (e.g., imitates, copies, and/or emulates) the display of information that is displayed by computer system 802 in response to computer system 610 detecting input 805a when a determination is made that computer system 802 is positioned at the predetermined location and if computer system 802 is displaying a non-sensitive type of user interface. As illustrated in FIG. 4C, computer system 610 displays media item identifier user interface object 830 as overlaid on top of the display of navigation user interface 612. In some embodiments, computer system 610 displays the entirety of playback user interface 812 in response to receiving the instructions from computer system 802. In some embodiments, computer system 610 ceases to display navigation user interface 612 as a part of displaying media item identifier user interface object 830.

At FIG. 4C, fan control user interface object 814A indicates that the external fan that corresponds to fan control user interface object 814A is operating at 80% power. At FIG. 4C, computer system 610 detects input 805cl that is directed to input mechanism 814a and/or computer system 802 detects input 805c2. In some embodiments, input 805c2 corresponds to a tap input, a swipe input, voice input, a long press (e.g., a tap and hold) a rotational input, an air gesture, a voice input, and/or a gaze input. In some embodiments, computer system 610 ceases to display media item identifier user interface object 830 in response to receiving instructions from computer system 802 that indicate that computer system 802 is moved away from the predetermined location (e.g., computer system 802 is decoupled from external charger 822). In some embodiments, computer system 802 continues to display control user interface 818 after computer system 802 has moved away from the predetermined location. In some embodiments, computer system 610 and computer system 802 concurrently display control user interface 818. In some embodiments, while computer system 802 displays control user interface 818, computer system 610 displays control user interface 818 in response to detecting input 805a.

FIG. 4D illustrates the behavior of computer systems 610 and computer system 802 in response to computer system 610 detecting inputs 805b or 805cl or in response to computer system 802 detecting input 805c2. Accordingly, FIG. 4D can follow either FIG. 4B or 4C. At FIG. 4D, computer system 610 (based on inputs 805b or 805c1) and/or computer system 802 (based on input 805c2) transmits instructions to the external fan device that corresponds to fan control user interface object 814A that cause the external fan to adjust the power of the external fan power from 80% to 50%. Accordingly, as illustrated in FIG. 4D, fan control user interface object 814A indicates that the external fan that corresponds to fan control user interface object 814A is operating at 50% power. Selection of fan control user interface object 814A while computer system 610 and/or computer system 610 displays fan control user interface object 814A adjusts the operation of the external fan.

Selection of a respective control (e.g., fan control user interface object 814A, light control user interface object 814B, and/or volume control user interface object 814C) that is displayed by computer system 802 does not modify the display on computer system 610 and vice versa. More specifically, in some embodiments, computer system 802 does not transmit instructions to computer system 610 that cause the display of computer system 610 to change as part of computer system 802 detecting input 805c2. In some embodiments, computer system 610 does not transmit instructions to computer system 802 that cause the display of computer system 802 to change as part of computer system 610 detecting inputs 805b or 805c1. In some embodiments, while computer system 802 displays controls user interface 818, computer system 610 does not modify display 604 in response to detecting input 805c1. In some embodiments, while computer system 802 displays controls user interface 818, computer system 610 ceases to display navigation user interface 612 in response to detecting input 805c1. In some embodiments, the above description of fan control user interface object 814A applies to both light control user interface object 814B, and volume control user interface object 814C and the respective external devices that correspond to light control user interface object 814B, and volume control user interface object 814C.

As illustrated in FIG. 4E, computer system 802 displays communication user interface 828. Communication user interface 828 corresponds to a communication application (e.g., a telephone application, a video conferencing application, an e-mail application, and/or a text messaging application) that is installed on computer system 802. Communication user interface 828 corresponds to a sensitive type of user interface (e.g., in contrast to playback user interface 812 which does not correspond to the sensitive type of user interface) (e.g., communication user interface 828 contains sensitive information (e.g., the telephone information of individuals and/or a live video conference between individuals)). In some embodiments, while computer system 802 displays playback user interface 812, in response to detecting an input (e.g., a tap input, an activation of a hardware button, and/or a swipe input), computer system 802 ceases to display playback user interface 812 and displays communication user interface 828. In some embodiments, computer system 802 displays communication user interface 828 in response to detecting an incoming call. In some embodiments, communication user interface 828 corresponds to a video conference user interface (e.g., a user interface that includes a live video conference between two individuals).

As illustrated in FIG. 4E, computer system 802 is coupled to external charger 822. Accordingly, at FIG. 4E, computer system 802 is positioned at the predetermined location. At FIG. 4E, computer system 610 detects input 805e that corresponds to activation of input mechanism 814a.

As illustrated FIG. 4F, in response to detecting input 805e, computer system 610 displays controls user interface 818. Because computer system 802 is displaying a user interface that contains sensitive information when computer system 610 detects input 805e, even though computer system 802 is positioned at the predetermined location, computer system 610 displays controls user interface 818, and computer system 802 does not display controls user interface 818. That is, computer system 802 does not display controls user interface 818 while computer system 802 displays a user interface that contains sensitive information even if computer system 802 is located at the predetermined location.

As illustrated in FIG. 4F, computer system 802 continues to display communication user interface 828 while computer system 610 displays controls user interface 818. In some embodiments, while computer system 802 displays communication user interface 828 and in response to detecting input 805e, computer system 610 transmits instructions to computer system 802 that cause computer system 802 to display controls user interface 818. In embodiments where computer system 802 displays controls user interface 818, computer system 802 ceases to display communication user interface 828 as a part of displaying controls user interface 818. In embodiments where computer system 802 displays controls user interface 818, computer system 802 concurrently displays communication user interface 828 and controls user interface 818.

Further at FIG. 4F, computer system 802 does not transmit instructions to computer system 610 that cause computer system 610 to mimic a portion of the display of computer system 802 (e.g., as described above in relation to FIG. 4C) in response to computer system 610 detecting input 805e. Computer system 610 does not a mimic the display of information displayed by computer system 802 while computer system 802 displays a user interface that contains sensitive information. In some embodiments, computer system 802 displays a video conference user interface that corresponds to a third type of user interface. In embodiments where computer system 802 displays the third type of user interface and in response to computer system 610 detecting an input while computer system 802 is positioned at the predetermined location, computer system 610 displays controls user interface 818 and computer system 802 does not (or does) display controls user interface 818. In embodiments where computer system 802 displays the third type of user interface and in response to computer system 610 detecting an input, computer system 610 mimics the display of information that is displayed by computer system 802. In some embodiments, input 805e corresponds to moving computer system 802 to the predetermined location (e.g., coupling computer system 802 to external charger 822). In some embodiments, computer system 610 detects input 805e on the surface of display 604. In some embodiments, computer system 610 is in communication with one or more cameras (e.g., external cameras and/or cameras that are integrated into computer system 610 and/or computer system 802). In embodiments when computer system 610 is in communication with one or more cameras, computer system 610 detects, via the one or more cameras, the presence of a user (e.g., a user positioned at a location that is proximate to computer system 610). In some embodiments, computer system 610 detects the presence of user in response to receiving a wireless communication (e.g., a Bluetooth, Wi-Fi, and/or Ultra-wideband) from computer system 802. In embodiments when computer system 610 detects the presence of the user, in response to detecting the presence of a user, computer system 610 displays a welcome user interface that includes a greeting message (e.g., “Welcome”) on display 604. In some embodiments, computer system 610 concurrently displays the greeting message with navigation user interface 612 and/or one or more user-based settings. In some embodiments, computer system 610 ceases to display navigation user interface 612 as a part of displaying the greeting message. In some embodiments, computer system 610 displays the greeting message for a predetermined amount of time (1, 3, 5, 10, 15, or 25 seconds).

FIG. 5 is a flow diagram illustrating a method (e.g., process 900) for displaying information via an external display based on the location of a computer system in accordance with some examples. Some operations in process 900 are, optionally, combined, the orders of some operations are, optionally, changed, and some operations are, optionally, omitted.

As described below, process 900 provides an intuitive way for displaying information via an external display based on the location of a computer system. Process 900 reduces the cognitive burden on a user for displaying information via an external display based on the location of a computer system thereby creating a more efficient human-machine interface. For battery-operated computing devices, enabling a user to display information via an external display based on the location of a computer system faster and more efficiently conserves power and increases the time between battery charges.

In some embodiments, process 900 is performed at a computer system (e.g., 100 and/or 610) that is in communication with a display component (e.g., 604) (e.g., a display screen and/or a touch-sensitive display) and a respective device (e.g., 802). In some embodiments, the computer system and/or the respective device is a watch, a phone, a tablet, a processor, a head-mounted display (HMD) device, and/or a personal computing device. In some embodiments, the computer system is in communication with one or more cameras (e.g., one or more telephoto, wide angle, and/or ultra-wide-angle cameras). In some embodiments, the computer system is in communication with one or more input devices (e.g., a physical input mechanism (e.g., a hardware input mechanism, a rotatable input mechanism, a crown, a knob, a dial, a physical slider, and/or a hardware button), a camera, a touch-sensitive display, a microphone, and/or a button). In some embodiments, the display component is included in the computer system. In some embodiments, the display component is not included in the computer system and is not included the respective device.

The computer system detects (902) an input (e.g., 805a and/or 805c1) (e.g., an input (e.g., tap input, a rotational input, a drag input, and/or a long-press input) on a physical device, a voice command, an air gesture/input, a mouse click, and/or an input that moves the respective device (e.g., a picking up input and/or a placing input (e.g., where the respective device is placed at a location))).

In response to (904) detecting the input (e.g., 805a and/or 805cl) and in accordance with a determination that a set of one or more criteria is met, the computer system causes (906) the respective device (e.g., 802) (e.g., by sending a request to the respective device) to display one or more controls (e.g., 814A, 814B, and/or 814C), wherein the set of one or more criteria includes a criterion that is met when the respective device is at (e.g., is connected to, is attached to, is connected to or attached to a device and/or an attachment point (e.g., a magnetic attachment point and/or a dongle attachment point)) a predetermined (e.g., predefined and/or pre-configured) location.

In response to (904) detecting the input and in accordance with a determination that the set of one or more criteria is not met, the computer system displays (908), via the display component (e.g., 604), the one or more controls (e.g., 814A, 814B, and/or 814C) without causing the respective device (e.g., 802) to display the one or more controls. Either display the one or more controls or cause the respective device to display the one or more controls based on whether the respective device is at the predetermined location allows for the computer system to intelligently and/or contextually determine where it is most likely for a user to be looking and/or wishing to interact and displaying the one or more controls there, thereby providing improved visual feedback to the user, reducing the number of inputs needed to perform an operation, providing additional control options without cluttering the user interface with additional displayed controls, and/or performing an operation when a set of conditions has been met without requiring further user input.

In some embodiments, the input (e.g., 805a and/or 805c1) is an input on a first physical input mechanism (e.g., 814a and/or 814b). In some embodiments, the computer system (e.g., 610) is in communication with the first physical input mechanism. The same input on the first physical input mechanism causing either display of the one or more controls or the respective device to display the one or more controls allows for the computer system to intelligently and/or contextually determine where it is most likely for a user to be looking and/or wishing to interact and displaying the one or more controls there, thereby providing improved visual feedback to the user, reducing the number of inputs needed to perform an operation, providing additional control options without cluttering the user interface with additional displayed controls, and/or performing an operation when a set of conditions has been met without requiring further user input.

In some embodiments, detecting the input (e.g., 805a and/or 805c1) includes detecting that the respective device (e.g., 802) is at a predetermined location (e.g., location of 822) in the physical environment. In some embodiments, the computer system detects that the respective device is at the predetermined location in the physical environment via one or more cameras in communication with the computer system and/or via the respective device (and/or another computer system and/or device) sending a status corresponds to the respective device being at the location. In some embodiments, detecting that the respective device is at the predetermined location includes detecting that the respective device is connected to (e.g., via a magnetic connection, an electronic connection, and/or a dongle, and/or physically coupled to and/or attached to) an object (e.g., the computer system, a different computer system than the computer system, and/or another type of object). Detecting the input to cause display of the one or more controls to include detecting that the respective device is at the predetermined location in the physical environment allows for the computer system to intelligently and/or contextually determine where it is most likely for a user to be looking and/or wishing to interact and displaying the one or more controls there, thereby providing improved visual feedback to the user, reducing the number of inputs needed to perform an operation, providing additional control options without cluttering the user interface with additional displayed controls, and/or performing an operation when a set of conditions has been met without requiring further user input.

In some embodiments, before detecting the input (e.g., 805a and/or 805c1), the computer system detects a presence (e.g., that a user is near a location and/or close to a location, that a user's voice, body-part, and/or biometric input has been detected) of a user. In some embodiments, in response to detecting the presence of the user, the computer system displays, via the display component (e.g., 604), an indication of a greeting for the user (e.g., as described above at FIG. 4F). In some embodiments, the indication of the greeting for the user is displayed differently for different users (and/or different profiles that are associated with users). In some embodiments, the greeting includes an animation of user interface objects changing to indicate one or more preferences for a particular user. Displaying the indication of the greeting for the user in response to detecting the presence of the user allows for the user to identify that the computer system recognizes the user, thereby providing improved visual feedback to the user and/or performing an operation when a set of conditions has been met without requiring further user input.

In some embodiments, in response to detecting the presence of the user, the computer system modifies one or more settings based on a set of one or more preferences of the user (e.g., as described above at FIG. 4B). In some embodiments, modifying the one or more settings includes causing the output of one or more devices (e.g., a thermostat, fan, light, set of blinds, window, door, and/or speaker) that correspond to the one or more settings to be adjusted (e.g., increased and/or decreased). In some embodiments, one or more outputs of the one or more devices are adjusted to one or more outputs that have been historically preferred (e.g., via a user setting and/or via historical data of the user setting the output of a device to be a certain value) by the user. Modifying the one or more settings based on the set of one or more preferences of the user in response to detecting the presence of the user allows for the computer system to automatically, without user input, adjust to the user without needing for the user to manually adjust different settings, thereby reducing the number of inputs needed to perform an operation, providing additional control options without cluttering the user interface with additional displayed controls, and/or performing an operation when a set of conditions has been met without requiring further user input.

In some embodiments, the one or more controls (e.g., 814A, 814B, and/or 814C) includes a first control (e.g., 814A, 814B, and/or 814C) that is displayed with a representation of a first value (e.g., 814A, 814B, and/or 814C at FIG. 4C). In some embodiments, the first value is selected at least based on one or more first preferences in the set of one or more preferences of the user (e.g., as described above at FIG. 4C). In some embodiments, the one or more controls (e.g., 814A, 814B, and/or 814C) includes a second control (e.g., 814A, 814B, and/or 814C) that is displayed with a representation of a second value (e.g., 814A, 814B, and/or 814C at FIG. 4C). In some embodiments, the first value is selected at least based on one or more second preferences in the set of one or more preferences of the user. In some embodiments, the one or more second preferences are different from the one or more first preferences (e.g., as described above at FIG. 4C). In some embodiments, in response to detecting selection of the second control, an output of a second respective device, different from the first respective device, is adjusted. In some embodiments, in response to detecting selection of the first control, an output of a first respective device is adjusted. The controls including representations of values selected based on different preferences of the user allows for multiple adjustments to be made automatically without user input and/or without needing for the user to manually adjust different settings, thereby reducing the number of inputs needed to perform an operation, providing additional control options without cluttering the user interface with additional displayed controls, and/or performing an operation when a set of conditions has been met without requiring further user input.

In some embodiments, the respective device (e.g., 802) is displaying a first user interface (e.g., 812) while the input (e.g., 805a and/or 805cl) was detected. In some embodiments, causing the respective device to display one or more controls (e.g., 814A, 814B, and/or 814C) (e.g., in response to detecting the input and in accordance with a determination that a set of one or more criteria is met) includes causing the respective device to replace display of the first user interface with display of the one or more controls (e.g., as described at FIG. 4C). In some embodiments, the first user interface includes a control that ceases to be displayed when the one or more controls are displayed. In some embodiments, in accordance with a determination that the set of one or more criteria is not met, the respective device continues to display the first user interface and does not replace display of the first user interface with display of the one or more controls. In some embodiments, different representations of the one or more controls are displayed depending on whether instructions are sent to the respective device or displayed by the computer system (e.g., the respective device displays a user interface with the one or more controls without other user-interface elements from another application while the computer system is configured to display a user interface with the one or more controls with user-interface elements from another application (such as described above with respect to the second portion in process 700)). Causing the respective device to replace display of the first user interface with display of the one or more controls allows for the computer system to control a user experience for a user on the respective device and/or ensure that the user has access to what the computer system determines to be needed, thereby providing improved visual feedback to the user, reducing the number of inputs needed to perform an operation, providing additional control options without cluttering the user interface with additional displayed controls, and/or performing an operation when a set of conditions has been met without requiring further user input.

In some embodiments, the display component (e.g., 604) is displaying information (e.g., information included in 612) over a first portion of a second user interface (e.g., 612), a second portion of the second user interface, and a third portion of the second user interface (e.g., as described above in relation to process 700) (e.g., where the first portion, the second portion, and the third portion are different and separate from each other (e.g., do not encompass and/or are not encompassed by each other)). In some embodiments, in response to detecting the input (e.g., 805a and/or 805cl) and in accordance with a determination that the set of one or more criteria is not met, the computer system moves (and/or resizing, shrinking, and/or adjusting) the information, such that the information is displayed on the first portion and the second portion of the second user interface and is not displayed on the third portion of the second user interface (e.g., 612 at FIG. 4B), wherein the one or more controls (e.g., 814A, 814B, and/or 814C) are displayed in the third portion of the second user interface (e.g., as described above in relation to process 700). In response to detecting the input and in accordance with the determination that the set of one or more criteria is not met, moving the information, such that the information is displayed on the first portion and the second portion of the second user interface and is not displayed on the third portion of the second user interface allows the computer system to intelligently and/or contextually display content in a particular portion and/or a user to more easily context switch between the information being displayed and the one or more user interface objects, thereby providing improved visual feedback to the user and/or performing an operation when a set of conditions has been met without requiring further user input.

In some embodiments, the computer system (e.g., 610) is in communication with a second physical input mechanism (e.g., 814a and/or 814b) and a first device (e.g., an external device and/or component and/or an internal device and/or component of the computer system) (e.g., different from the respective device). In some embodiments, the computer system detects an input (e.g., 805a and/or 805c1) (e.g., an input (e.g., a tap input and/or a rotational input) on a rotatable input mechanism) (and, in some embodiments, a non-tap and/or rotational input, such as a mouse click, gaze input, voice input and/or command, air gesture (e.g., a tap air gesture, a pinch gesture, and/or a flicking air gesture)) directed to the second physical input mechanism. In some embodiments, in response to detecting the input directed to the second physical input mechanism (e.g., and in accordance with a determination that the at least one of the one or more controls is configured to be modified by input directed to the second physical input mechanism), the computer system updates display (e.g., via the display component or the respective device) of at least one of the one or more controls (e.g., 814A, 814B, and/or 814C) (e.g., the at least one of the one or more controls corresponds to (e.g., is associated and/or assigned to) the first device) based on the input that is directed to the second physical input mechanism (e.g., as described at FIG. 4D). In some embodiments, in response to detecting the input directed to the second physical input mechanism, the computer system causes the first device to provide output based on the input directed to the second physical input mechanism (e.g., as described above at FIG. 4D) (e.g., without causing a second device that is different from and/or a different type of device than the first device to provide output based on the input directed to the second physical input mechanism). In some embodiments, the second device corresponds to a control not included in the at least one of the one or more controls such that input detected to change the control causes the second device to provide output without causing the first device to provide output. Updating display of the at least one of the one or more controls and causing the first device to provide output based on the input directed to the second physical input mechanism allows for users to control the output of the first device with use of the second physical input while displaying the one or more user interface objects, thereby providing improved visual feedback to the user and/or performing an operation when a set of conditions has been met without requiring further user input.

In some embodiments, the input (e.g., 805a and/or 805c1) directed to the second physical input mechanism (e.g., 814a and/or 814b) is detected while causing the respective device (e.g., 802) to display the one or more controls (e.g., 814A, 814B, and/or 814C). In some embodiments, in response to detecting the input directed to the second physical input mechanism, the computer system updates, via the display component (e.g., 604), display of at least one of the one or more controls (e.g., the at least one of the one or more controls corresponds to (e.g., is associated and/or assigned to) the first device) based on the input that is directed to the second physical input mechanism (e.g., as described above at FIG. 4C). In response to detecting the input directed to the second physical input mechanism, updating display of the one or more controls via the display component allows for users to control the output of the first device with use of the second physical input while displaying the one or more user interface objects, thereby providing improved visual feedback to the user and/or performing an operation when a set of conditions has been met without requiring further user input.

In some embodiments, the input (e.g., 805a and/or 805c1) directed to the second physical input mechanism (e.g., 814a and/or 814b) is detected while displaying, via the display component (e.g., 604), the one or more controls (e.g., 814A, 814B, and/or 814C) and while not causing the respective device (e.g., 802) to display the one or more controls. In some embodiments, in response to detecting the input directed to the second physical input mechanism, the computer system forgoes causing a user interface (e.g., 812) (and/or, in some embodiments, a display) of the respective device to be updated. In response to detecting the input directed to the second physical input mechanism, forgoing causing a user interface of the respective device to be updated when the display component is displaying the one or more controls and while not causing the respective device to display the one or more controls allows for the respective device to continue to display content without being affected by the input directed to the second physical input mechanism, thereby providing additional control options without cluttering the user interface with additional displayed controls and/or performing an operation when a set of conditions has been met without requiring further user input.

In some embodiments, while the respective device (e.g., 802) is displaying the one or more controls (e.g., 814A, 814B, and/or 814C), the computer system detects a first set of one or more inputs (e.g., 805a, 805c1, and/or 805c2) (e.g., and/or receiving an indication of an input was detected via the respective device) including an input (e.g., 805a, and/or 805c1) directed to a first control not included in the one or more controls. In some embodiments, the first control is not displayed by the respective device. In some embodiments, in response to detecting the set of one or more inputs (and/or the input directed to the first control not included in the one or more controls) including the input (e.g., 805a and/or 805c1) directed to the first control not included in the one or more controls, the computer system causes a second device (e.g., the respective device and/or a device other than the respective device) to provide output based on the input directed to the first control (e.g., as described above at FIG. 4D). In some embodiments, while the respective device is not displaying the one or more controls, the computer system detects an input (e.g., and/or receiving an indication of an input was detected via the respective device) that was directed to the respective device. In some embodiments, in response to detecting the input that was directed to the respective device, the computer system does not cause the second device to provide output based on the input that was directed to the respective device. Causing a second device to provide output in response to detecting the set of one or more inputs provides the user with more control over the second device, the respective device, and/or the computer system by allowing the second device to be adjusted with input that is directed to a control on the respective device, thereby providing additional control options without cluttering the user interface with additional displayed controls.

In some embodiments, the respective device (e.g., 802) is caused to display the one or more controls (e.g., 814A, 814B, and/or 814C) in a first arrangement (e.g., an arrangement of display, in a square, in a line (e.g., vertically and/or horizontally aligned), in a circle, and/or in another shape). In some embodiments, the computer system (e.g., 610) displays, via the display component (e.g., 604), the one or more controls in a second arrangement that is different from the first arrangement. Displaying the one or more controls in the first arrangement via the respective device and the second arrangement via the display component allows for the computer system to take advantage of characteristics (e.g., size, shape, resolution, etc.) of a display being used for displaying the one or more controls, thereby providing improved visual feedback to the user and/or performing an operation when a set of conditions has been met without requiring further user input.

In some embodiments, the one or more controls (e.g., 814A, 814B, and/or 814C) are displayed with a first visual appearance while the respective device (e.g., 802) is caused to display the one or more controls. In some embodiments, the one or more controls are displayed with a second visual appearance that is different from (e.g., difference in shape and/or difference in color) the first visual appearance while the computer system (e.g., 610) is displaying (e.g., concurrently displaying) the one or more controls via the display component (e.g., 604). Displaying the one or more controls with the first visual appearance via the respective device and the second visual appearance via the display component allows for the computer system to take advantage of characteristics (e.g., size, shape, resolution, etc.) of a display being used for displaying the one or more controls, thereby providing improved visual feedback to the user and/or performing an operation when a set of conditions has been met without requiring further user input.

In some embodiments, the one or more controls (e.g., 814A, 814B, and/or 814C) occupy a first percentage (e.g., 1-70%) of a display (e.g., 804) of the respective device (e.g., 802) (and, in some embodiments, a user interface displayed via the respective device) while the respective device is caused to display the one or more controls. In some embodiments, the one or more controls occupy a second percentage (e.g., 1-70%) of a display (e.g., 604) that is communication with the computer system (e.g., 610) (and, in some embodiments, a user interface displayed via the computer system) while the computer system is displaying the one or more controls via the display component (e.g., 604). In some embodiments, the second percentage is smaller than the first percentage. Displaying the one or more controls to occupy the first percentage of the display of the respective device and the second percentage of the display of the computer display while the computer system is displaying the one or more controls via the display component allows for the computer system to take advantage of characteristics (e.g., size, shape, resolution, etc.) of a display being used for displaying the one or more controls, thereby providing improved visual feedback to the user and/or performing an operation when a set of conditions has been met without requiring further user input.

In some embodiments, the computer system (e.g., 610) is in communication with a third physical input mechanism (e.g., 814a and/or 814b). In some embodiments, the predetermined location (e.g., location of 822) is a location that is near (e.g., no more than a predetermined distance (e.g., 1-20 centimeters)) the third physical input mechanism (e.g., as described above at FIG. 4B). The predetermined location being a location that is near the third physical input mechanism allows for display to be intelligently and/or contextually performed based on predicted attention of a user, thereby providing improved visual feedback to the user, providing additional control options without cluttering the user interface with additional displayed controls, and/or performing an operation when a set of conditions has been met without requiring further user input.

In some embodiments, the computer system (e.g., 610) is in communication with a fourth physical input mechanism (e.g., 814a and/or 814b). In some embodiments, the predetermined location (e.g., location of 822) is above the fourth physical input mechanism (e.g., as described above at FIG. 4B) (e.g., above, such as when looking up from the ground and/or the surface/crust of the Earth). The predetermined location being a location that is above the fourth physical input mechanism allows for display to be intelligently and/or contextually performed based on predicted attention of a user, thereby providing improved visual feedback to the user, providing additional control options without cluttering the user interface with additional displayed controls, and/or performing an operation when a set of conditions has been met without requiring further user input.

In some embodiments, the fourth physical input mechanism (e.g., 814a and/or 814b) has a physically pressed (e.g., up and/or raised) state and a physically unpressed (e.g., down and/or lowered) state (e.g., as described above at FIG. 4B). In some embodiments, the respective device can only be at the predetermined location while the fourth physical input mechanism is in the pressed state (or, in other examples, the unpressed state), where the respective device is positioned on top of and/or above the fourth physical input mechanism. In some embodiments, a top of the fourth physical input mechanism is higher in the up state than the down state. In some embodiments, a side of the fourth physical input mechanism is visible in the up state and not visible in the down state. The fourth physical input mechanism having a physically pressed state and a physically unpressed state allows for the fourth physical input mechanism to occupy a different visual space depending on a state of the fourth physical input mechanism, thereby providing additional control options without cluttering the user interface with additional displayed controls.

In some embodiments, the set of one or more criteria includes a criterion that is met when the respective device (e.g., 802) is magnetically connected (e.g., to the predetermined location and/or a surface (e.g., a magnetic surface) at the predetermined location) (e.g., as described above at FIG. 4C). In some embodiments, the set of one or more criteria includes a criterion that is met when the respective device is connected to the predetermined location via a dongle, an adhesive, and/or an electronic connection. The set of one or more criteria including a criterion that is met when the respective device is magnetically connected allows for the computer system to react to changes that occur without a physical and/or wireless connection between devices, thereby reducing the number of inputs needed to perform an operation and/or performing an operation when a set of conditions has been met without requiring further user input.

In some embodiments, while the respective device (e.g., 812) is at the predetermined location (e.g., location of 822), the respective device (e.g., 802) is in a charging state (e.g., as described above at FIG. 4C) (e.g., is being charged and/or is configured to be charged via a connection between the respective device and the predetermined location). The respective device being in a charging state while the respective device is at the predetermined location allows for the respective device to take advantage of being in a stationary area and/or predetermined location, thereby reducing the number of inputs needed to perform an operation and/or performing an operation when a set of conditions has been met without requiring further user input.

Note that details of the processes described above with respect to process 900 (e.g., FIG. 5) are also applicable in an analogous manner to other methods described herein. For example, process 700 optionally includes one or more of the characteristics of the various methods described above with reference to process 900. For example, a display component can display or not the display the user interface discussed in process 700 based on whether a respective computer system is positioned at a respective location or not. For brevity, these details are not repeated below.

FIG. 6 is a flow diagram illustrating a method (e.g., process 1000) for selectively displaying a user interface via an external display in accordance with some examples. Some operations in process 1000 are, optionally, combined, the orders of some operations are, optionally, changed, and some operations are, optionally, omitted.

As described below, process 1000 provides an intuitive way for selectively displaying a user interface via an external display. Process 1000 reduces the cognitive burden on a user for selectively displaying a user interface via an external display, thereby creating a more efficient human-machine interface. For battery-operated computing devices, enabling a user to selectively display a user interface via an external display faster and more efficiently conserves power and increases the time between battery charges.

In some embodiments, process 1000 is performed at a computer system (e.g., 610) that is in communication with a display component (e.g., 604) (e.g., a display screen and/or a touch-sensitive display) and a respective device (e.g., 802). In some embodiments, the computer system and/or the respective device is a watch, a phone, a tablet, a processor, a head-mounted display (HMD) device, and/or a personal computing device. In some embodiments, the computer system is in communication with one or more cameras (e.g., one or more telephoto, wide angle, and/or ultra-wide-angle cameras). In some embodiments, the computer system is in communication with one or more input devices (e.g., a physical input mechanism (e.g., a hardware input mechanism, a rotatable input mechanism, a crown, a knob, a dial, a physical slider, and/or a hardware button), a camera, a touch-sensitive display, a microphone, and/or a button). In some embodiments, the display component is included in the computer system. In some embodiments, the display component is not included in the computer system and is not included the respective device.

While the respective device (e.g., 802) is displaying a respective user interface (e.g., 812 and/or 828), the computer system detects (1002) an input (e.g., 805a, 805c1, and/or 805e) (e.g., an input (e.g., tap input, a rotational input, a drag input, and/or a long-press input) on a physical device, a voice command, an air gesture/input, a mouse click, and/or an input that moves the respective device (e.g., a picking up input and/or a placing input (e.g., where the respective device is placed at a location)).

In response to (1104) detecting the input (e.g., 805a, 805c1, and/or 805e) and in accordance with a determination that the respective user interface (e.g., 812 and/or 828) is a first type of user interface (e.g., as described above at FIGS. 4C and 4E) (e.g., a user interface that includes visual information that is determined to be non-sensitive, non-private information, not determined to be a user interface that the computer system should maintain display of, and/or not determined to be better displayed by the computer system), the computer system causes (1006) the respective device (e.g., 802) to display one or more controls (e.g., 814A, 814B, and/or 814C).

In response to (1004) detecting the input and in accordance with a determination that the respective user interface (e.g., 812 and/or 828) is a second type of user interface (e.g., as described above at FIGS. 4C and 4E) (e.g., a user interface that includes visual information that is determined to be sensitive and/or private information) (e.g., an incoming and/or active communication (e.g., call, video, and/or messaging) user interface, a financial and/or account information user interface, and/or a user interface that requires authentication to be displayed) that is different from the first type of user interface, the computer system displays (1008), via the display component (e.g., 604), the one or more controls (e.g., 814A, 814B, and/or 814C) without causing the respective device (e.g., 802) to display the one or more controls. Selectively causing the respective device to display the one or more controls in accordance with a determination that the respective user interface is the first type or the second type of user interface allows for the respective device to selectively transition away from what is being displayed by the respective device, thereby providing improved security, reducing the number of inputs needed to perform an operation, and/or performing an operation when a set of conditions has been met without requiring further user input.

In some embodiments, detecting the input (e.g., 805a, 805c1, and/or 805e) includes detecting an input directed to (e.g., on, in the direction of, and/or physically touching) a first physical input mechanism (e.g., 814a and/or 814b) (e.g., a rotatable input mechanism) (e.g., a hardware input mechanism, a rotatable input mechanism, a crown, a knob, a dial, a physical slider, and/or a hardware button). In some embodiments, the computer system (e.g., 610) is in communication with the first physical input mechanism.

In some embodiments, detecting the input (e.g., 805a, 805c1, and/or 805e) includes detecting that the respective device (e.g., 802) is at a predetermined location in the physical environment (e.g., location of 822). In some embodiments, detecting that the respective device is at the predetermined location includes detecting that the respective device is connected to (e.g., via a magnetic connection, an electronic connection, and/or a dongle, and/or physically coupled to and/or attached to) an object. Having the input include detecting that the respective device is at the predetermined location in the physical environment allows for the computer system to intelligently and/or contextually determine where it is most likely for a user to be looking and/or wishing to interact and displaying the one or more controls there, thereby providing improved visual feedback to the user, reducing the number of inputs needed to perform an operation, providing additional control options without cluttering the user interface with additional displayed controls, and/or performing an operation when a set of conditions has been met without requiring further user input.

In some embodiments, in response to detecting the input (e.g., 805a, 805cl, and/or 805e) and in accordance with a determination that the respective user interface (e.g., 812 and/or 828) is the first type of user interface, the computer system causes the respective device (e.g., 802) to cease displaying at least a portion of the respective user interface (e.g., as described above at FIG. 4C) (while, in some embodiments, continuing to display another portion of the respective user interface). In some embodiments, in response to detecting the input and in accordance with a determination that the respective user interface is the first type of user interface, the computer system causes the respective device to cease displaying the respective user interface. In response to detecting the input and in accordance with the determination that the respective user interface is the first type of user interface, causing the respective device to cease displaying at least the portion of the respective user interface allows for the respective device to selectively display such visual information based on what the respective device was previously displaying, thereby providing improved security, reducing the number of inputs needed to perform an operation, and/or performing an operation when a set of conditions has been met without requiring further user input.

In some embodiments, the second type of user interface is a communication user interface (e.g., 828) (e.g., a video messaging user interface and/or a live video communication user interface) (e.g., a digital communication user interface, a text messaging user interface, a social media user interface, a phone call user interface, and/or a media sharing user interface).

In some embodiments, the second type of user interface is a user interface that includes (e.g., and/or is configured to include) sensitive data (e.g., as described above at FIG. 4E).

In some embodiments, the one or more controls (e.g., 814A, 814B, and/or 814C) are displayed with a first visual appearance (e.g., appearance of 814A, 814B, and/or 814C at FIGS. 4C and 4D) while the respective device (e.g., 802) is displaying the one or more controls. In some embodiments, the one or more controls are displayed with a second visual appearance (e.g., appearance of 814A, 814B, and/or 814C at FIGS. 4B and/or 4F) while the one or more controls are being displayed via the display component (e.g., 604). In some embodiments, the second visual appearance is different from (e.g., difference shape and/or color) the first visual appearance. Displaying the one or more controls with the first visual appearance via the respective device and the second visual appearance via the display component allows for the computer system to take advantage of characteristics (e.g., size, shape, resolution, etc.) of a display being used for displaying the one or more controls, thereby providing improved visual feedback to the user and/or performing an operation when a set of conditions has been met without requiring further user input.

In some embodiments, in response to detecting the input (e.g., 805a, 805c1, and/or 805e) and in accordance with a determination that the respective device (e.g., 802) is not at a predetermined location (e.g., location of 822), the computer system displays, via the display component (e.g., 604), the one or more controls (e.g., 814A, 814B, and/or 814C) (without, in some embodiments, causing the respective device to display one or more controls). In response to detecting the input and in accordance with the determination that the respective device is not at the predetermined location, displaying, via the display component, the one or more controls allows for the display component to display the one or more controls regardless of where the respective device is located and/or what is displayed by the respective device allows for users to know to be able to rely on the display component for displaying the one or more controls, thereby providing improved visual feedback to the user and/or performing an operation when a set of conditions has been met without requiring further user input.

In some embodiments, the computer system (e.g., 610) is in communication with a first physical input mechanism (e.g., 814a and/or 814b). In some embodiments, the predetermined location is a location that is near (e.g., no more than a predetermined distance (e.g., 1-20 centimeters)) the first physical input mechanism (e.g., as described above at FIG. 4B). The predetermined location being a location that is near the first physical input mechanism allows for display to be intelligently and/or contextually performed based on predicted attention of a user, thereby providing improved visual feedback to the user, providing additional control options without cluttering the user interface with additional displayed controls, and/or performing an operation when a set of conditions has been met without requiring further user input.

In some embodiments, the computer system (e.g., 610) is in communication with a second physical input mechanism (e.g., 814a and/or 814b). In some embodiments, the predetermined location is a location that is above the second physical input mechanism (e.g., as described above at FIG. 4B) (e.g., above, such as when looking up from the ground and/or the surface/crust of the Earth). The predetermined location being a location that is near the second physical input mechanism allows for display to be intelligently and/or contextually performed based on predicted attention of a user, thereby providing improved visual feedback to the user, providing additional control options without cluttering the user interface with additional displayed controls, and/or performing an operation when a set of conditions has been met without requiring further user input.

In some embodiments, detecting that the respective device (e.g., 802) is at the predetermined location (e.g., location of 822) includes detecting that the respective device is magnetically connected to the predetermined location (e.g., as described above at FIG. 4C). Having detecting include detecting that the respective device is magnetically connected to the predetermined location allows for the computer system to react to changes that occur without a physical and/or wireless connection between devices, thereby reducing the number of inputs needed to perform an operation and/or performing an operation when a set of conditions has been met without requiring further user input.

In some embodiments, the respective device (e.g., 802) is in a charging state while at the predetermined location (e.g., is being charged and/or is configured to be charged via a connection between the respective device and the predetermined location) (e.g., as described above at FIG. 4C). The respective device being in a charging state while the respective device is at the predetermined location allows for the respective device to take advantage of being in a stationary area and/or predetermined location, thereby reducing the number of inputs needed to perform an operation and/or performing an operation when a set of conditions has been met without requiring further user input.

Note that details of the processes described above with respect to method 1100 (e.g., FIG. 6) are also applicable in an analogous manner to the methods described herein. For example, process 700 optionally includes one or more of the characteristics of the various methods described above with reference to process 1000. For example, the user interface discussed at process 700 will not be displayed be a display component if it is determined that the user interface is a respective type of user interface. For brevity, these details are not repeated below.

This disclosure, for purpose of explanation, has been described with reference to specific embodiments. The discussions above are not intended to be exhaustive or to limit the disclosure and/or the claims to the specific embodiments. Modifications and/or variations are possible in view of the disclosure. Some embodiments were chosen and described in order to explain principles of techniques and their practical applications. Others skilled in the art are thereby enabled to utilize the techniques and various embodiments with modifications and/or variations as are suited to a particular use contemplated.

Although the disclosure and embodiments have been fully described with reference to the accompanying drawings, it is to be noted that various changes and/or modifications will become apparent to those skilled in the art. Such changes and/or modifications are to be understood as being included within the scope of this disclosure and embodiments as defined by the claims.

It is the intent of this disclosure that any personal information of users should be gathered, managed, and handled in a way to minimize risks of unintentional and/or unauthorized access and/or use.

Therefore, although this disclosure broadly covers use of personal information to implement one or more embodiments, this disclosure also contemplates that embodiments can be implemented without the need for accessing such personal information.

What is claimed is:

1. A method, comprising:
at a computer system that is in communication with a display component and a respective device:
detecting an input; and
in response to detecting the input:
in accordance with a determination that a set of one or more criteria is met, causing the respective device to display one or more controls, wherein the set of one or more criteria includes a criterion that is met when the respective device is at a predetermined location; and
in accordance with a determination that the set of one or more criteria is not met, displaying, via the display component, the one or more controls without causing the respective device to display the one or more controls.

2. The method of claim 1, wherein the input is an input on a first physical input mechanism, and wherein the computer system is in communication with the first physical input mechanism.

3. The method of claim 1, wherein detecting the input includes detecting that the respective device is at a predetermined location in the physical environment.

4. The method of claim 1, further comprising:
before detecting the input, detecting a presence of a user; and
in response to detecting the presence of the user, displaying, via the display component, an indication of a greeting for the user.

5. The method of claim 4, further comprising:
in response to detecting the presence of the user, modifying one or more settings based on a set of one or more preferences of the user.

6. The method of claim 4, wherein the one or more controls include:
a first control that is displayed with a representation of a first value, wherein the first value is selected at least based on one or more first preferences in the set of one or more preferences of the user; and
a second control that is displayed with a representation of a second value, wherein the first value is selected at least based on one or more second preferences in the set of one or more preferences of the user, and wherein the one or more second preferences are different from the one or more first preferences.

7. The method of claim 1, wherein the respective device is displaying a first user interface while the input was detected, and wherein causing the respective device to display one or more controls includes causing the respective device to replace display of the first user interface with display of the one or more controls.

8. The method of claim 1, wherein the display component is displaying information over a first portion of a second user interface, a second portion of the second user interface, and a third portion of the second user interface, the method further comprising:
in response to detecting the input and in accordance with a determination that the set of one or more criteria is not met, moving the information, such that the information is displayed on the first portion and the second portion of the second user interface and is not displayed on the third portion of the second user interface, wherein the one or more controls are displayed in the third portion of the second user interface.

9. The method of claim 1, wherein the computer system is in communication with a second physical input mechanism and a first device, the method further comprising:
detecting an input directed to the second physical input mechanism; and
in response to detecting the input directed to the second physical input mechanism:
updating display of at least one of the one or more controls based on the input that is directed to the second physical input mechanism; and
causing the first device to provide output based on the input directed to the second physical input mechanism.

10. The method of claim 9, wherein the input directed to the second physical input mechanism is detected while causing the respective device to display the one or more controls, the method further comprising:
in response to detecting the input directed to the second physical input mechanism, updating, via the display component, display of at least one of the one or more controls based on the input that is directed to the second physical input mechanism.

11. The method of claim 10, wherein the input directed to the second physical input mechanism is detected while displaying, via the display component, the one or more controls and while not causing the respective device to display the one or more controls, the method further comprising:
in response to detecting the input directed to the second physical input mechanism, forgoing causing a user interface of the respective device to be updated.

12. The method of claim 1, further comprising:
while the respective device is displaying the one or more controls, detecting a first set of one or more inputs including an input directed to a first control not included in the one or more controls; and
in response to detecting the set of one or more inputs including the input directed to the first control not included in the one or more controls, causing a second device to provide output based on the input directed to the first control.

13. The method of claim 1, wherein the respective device is caused to display the one or more controls in a first arrangement, and wherein the computer system displays, via the display component, the one or more controls in a second arrangement that is different from the first arrangement.

14. The method of claim 1, wherein the one or more controls are displayed with a first visual appearance while the respective device is caused to display the one or more controls, and wherein the one or more controls are displayed with a second visual appearance that is different from the first visual appearance while the computer system is displaying the one or more controls via the display component.

15. The method of claim 1, wherein:
the one or more controls occupy a first percentage of a display of the respective device while the respective device is caused to display the one or more controls;
the one or more controls occupy a second percentage of a display that is communication with the computer system while the computer system is displaying the one or more controls via the display component; and
the second percentage is smaller than the first percentage.

16. The method of claim 1, wherein the computer system is in communication with a third physical input mechanism, and wherein the predetermined location is a location that is near the third physical input mechanism.

17. The method of claim 1, wherein the computer system is in communication with a fourth physical input mechanism, and wherein the predetermined location is above the fourth physical input mechanism.

18. The method of claim 17, wherein the fourth physical input mechanism has a physically pressed state and a physically unpressed state.

19. The method of claim 1, wherein the set of one or more criteria includes a criterion that is met when the respective device is magnetically connected.

20. The method of claim 1, wherein, while the respective device is at the predetermined location, the respective device is in a charging state.

21. A non-transitory computer-readable storage medium storing one or more programs configured to be executed by one or more processors of a computer system that is in communication with a display component and a respective device, the one or more programs including instructions for:
detecting an input; and
in response to detecting the input:
in accordance with a determination that a set of one or more criteria is met, causing the respective device to display one or more controls, wherein the set of one or more criteria includes a criterion that is met when the respective device is at a predetermined location; and
in accordance with a determination that the set of one or more criteria is not met, displaying, via the display component, the one or more controls without causing the respective device to display the one or more controls.

22. A computer system that is in communication with a display component and a respective device, comprising:
one or more processors; and
memory storing one or more programs configured to be executed by the one or more processors, the one or more programs including instructions for:
detecting an input; and
in response to detecting the input:
in accordance with a determination that a set of one or more criteria is met, causing the respective device to display one or more controls, wherein the set of one or more criteria includes a criterion that is met when the respective device is at a predetermined location; and
in accordance with a determination that the set of one or more criteria is not met, displaying, via the display component, the one or more controls without causing the respective device to display the one or more controls.
